(19) United States
(12) Patent Application Publication
(10) Pub. No.: US 2026/0307740 A1
(43) Pub. Date: Oct. 8, 2026

(54) TEMPORARY BARRIER FOR FLATBED TRUCKS

(71) Applicant: Benjamin Buchanon ANSON, Lasalle (CA)

(72) Inventor: Benjamin Buchanon ANSON, Lasalle (CA)

(21) Appl. No.: 19/641,487

(22) Filed: Apr. 7, 2026

Related U.S. Application Data
(60) Provisional application No. 63/784,598, filed on Apr. 7, 2025.

(51) Int. Cl. B62D 33/033

(52) U.S. Cl. CPC B62D 33/033

(57) ABSTRACT

A temporary barrier for a flatbed of a truck comprises front and rear end posts and intermediate posts. The flatbed has a frame with outer sides having pockets with top and bottom openings and platform. The end, front and rear posts are vertical elongate embers having respective bottom portions thereof that are fitted within the pockets and are mounted thereto via respective mounting assemblies. A strap structure is mounted to the front and rear end posts and to the intermediate posts.

### CROSS-REFERENCE TO RELATED APPLICATIONS

The present application claims priority on U.S. Provisional Patent Application Ser. No. 63/784,598 filed on Apr. 7, 2025 and incorporated herein by reference in its entirety.

### TECHNICAL FIELD

The present disclosure generally relates to temporary barriers. More particularly, but not exclusively, the present disclosure relates to a temporary barrier for flatbed trucks.

### BACKGROUND

A flatbed truck is a type of vehicle that features a flat, open bed without any sides or a roof. The bed is usually made of metal or wood and can be used to transport a variety of large or heavy items that do not require the protection of an enclosed cargo area. Flatbed trucks are versatile and widely used in industries such as construction, logistics, and transportation. Temporary barriers for flatbed trucks are often used in various situations to help secure cargo, provide safety during transportation, or protect workers and pedestrians around construction zones, loading areas, or hazardous sites. These barriers are typically made from materials like plastic, metal, or concrete and are designed to be portable and easy to set up. In many cases, temporary barriers add extra weight to the flatbed, which can reduce the overall weight capacity available for cargo. This can lead to less efficient load management and may necessitate using heavier trucks or vehicles. Installing and removing temporary barriers can take time, especially if they are bulky or require tools for securing. This can delay loading and unloading processes, potentially leading to time inefficiencies. Depending on the size of the truck, the barriers can take up significant space, potentially reducing the number of goods that can be loaded. This could increase transportation costs since fewer items can be carried per trip.

### OBJECTS

It is an object of the present disclosure to provide a temporary barrier.

It is an object of the present disclosure to provide a temporary barrier for flatbed trucks.

### SUMMARY

In accordance with an aspect of the present disclosure, there is provided a temporary barrier for a flatbed of a truck, the flatbed comprising a frame structure with a platform extending therein and defining front and rear ends thereof, the frame structure defining outer sides extending along and downwardly of the platform, the outer sides comprising pockets having top and bottom openings, the temporary barrier comprising: front and rear end posts comprising: respective end post elongate vertical members having an end post bottom portion thereof for being placed within the pocket; and respective end post mounting assemblies for mounting the end post bottom portions to the pockets; intermediate posts comprising: respective intermediate post elongate vertical members having an intermediate post bottom portion thereof for being placed within the pocket; and respective intermediate post mounting assemblies for mounting the intermediate post bottom portions to the pockets; and a strap structure mounted to the front and rear posts and the intermediate posts.

In an embodiment, the intermediate post vertical members respectively comprise an upper stopper element for engaging the pocket during insertion of the intermediate post bottom portion into the pocket to stop further insertion therein. In an embodiment, the upper stopper comprises a plate member.

In an embodiment, the intermediate post bottom portion defines a bottommost part that outwardly extends from the bottom opening of the pocket when the bottom portion is fully inserted in the pocket, wherein the intermediate post mounting assemblies respectively comprises a stopper element at the bottommost part for stopping removal of the intermediate post from the pocket via engagement with the pocket. In an embodiment, the bottommost part defining openings for receiving the bottom stopper. In an embodiment, the bottom stopper comprises a pin.

In an embodiment, the intermediate post mounting assemblies respectively comprise movable hook members outwardly protruding from openings formed in a bottommost part of the intermediate post bottom portion that are inwardly movable during insertion of the intermediate post bottom portion into the pocket, the bottommost part outwardly extending from the bottom opening of the pocket providing the hooks to outwardly protrude for stopping removal of the intermediate post from the pocket via engagement with the pocket. In an embodiment, the hook members are biased to outwardly protrude from the openings in the bottommost part via a biasing element. In an embodiment, the intermediate post mounting assemblies respectively comprise movable lever tabs outwardly protruding from openings formed in the intermediate post elongate vertical members and being connected to the hooks via a linkage structure, wherein inward pushing of lever tabs into the openings of the intermediate post elongate vertical members causes inward movement of the hooks into the openings of the bottommost part.

In an embodiment, the end post vertical members respectively comprise an upper stopper element for engaging the pocket during insertion of the end post bottom portion into the pocket to stop further insertion therein. In an embodiment, the upper stopper element comprises a plate.

In an embodiment, the end post bottom portion defines a bottommost part that outwardly extends from the bottom opening of the pocket when the bottom portion is fully inserted in the pocket, wherein the end post mounting assemblies respectively comprise a bottom stopper element at the bottommost part for stopping removal of the end post from the pocket via engagement with the pocket. In an embodiment, bottommost part defining openings for receiving the bottom stopper. In an embodiment, the bottom stopper comprises a pin.

In an embodiment, the end post bottom portion defines a bottommost part that outwardly extends from the bottom opening of the pocket when the bottom portion is fully inserted in the pocket, the mounting assemblies respectively comprise: a top clamping plate mounted to the end post elongate vertical member for engaging the pocket during insertion of the end post bottom portion into the pocket to stop further insertion therein; and a bottom clamping plate mounted to the bottommost part for stopping removal of the end post from the pocket via engagement with the pocket, wherein the top and bottom clamping plates are interconnected.

In an embodiment, the vertical elongate members of the end posts and/or the rear posts comprise external material that is removable for fitting into a given pocket size. In an embodiment, the strap structure comprises a plurality of straps.

In an embodiment, one of the front and rear end posts comprise connectors for connecting the straps thereof. In an embodiment, the connectors are selected from the group consisting of connecting ratchets, winches, quick links, hooks and any combination thereof.

In an embodiment, the intermediate posts comprise clamps for receiving and clamping the straps.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a side view of a flatbed truck with a temporary barrier in accordance with a non-restrictive illustrative embodiment of the present disclosure;

FIG. 2 is a top and rear perspective view of a flatbed truck with a partial temporary barrier in accordance with a non-restrictive illustrative embodiment of the present disclosure;

FIG. 3 is an outer side view of a front end post of a temporary barrier mounted on a flatbed truck in accordance with a non-restrictive illustrative embodiment of the present disclosure;

FIG. 4 is an outer and rear side perspective view of the end post of FIG. 3;

FIG. 5 is an inner side perspective view of the end post of FIG. 3;

FIG. 6 is an outer side view of the end post of FIG. 3 being disconnected from the flatbed truck with the mounting assembly thereof shown in an exploded position in accordance with a non-restrictive illustrative embodiment of the present disclosure;

FIG. 7 is an outer, bottom and front side perspective view of the end post of FIG. 6;

FIG. 8 is an outer, top and rear side perspective view of the end post of FIG. 6;

FIG. 9 is an enlarged view of portion 9 of FIG. 7;

FIG. 9a is an enlarged view of the bottom plate and shims of the clamping structure shown in FIG. 9;

FIG. 10 is an outer side view of a rear end post of a temporary barrier mounted on a flatbed truck in accordance with a non-restrictive illustrative embodiment of the present disclosure;

FIG. 11 is an outer side perspective view of the end post of FIG. 10;

FIG. 12 is an inner side perspective view of the end post of FIG. 10;

FIG. 13 is an outer side view of a front end post of a temporary barrier mounted on a flatbed truck in accordance with another non-restrictive illustrative embodiment of the present disclosure;

FIG. 14 is an outer side view of a rear end post of a temporary barrier mounted on a flatbed truck in accordance with another non-restrictive illustrative embodiment of the present disclosure;

FIG. 15 is an outer side view of an intermediary post of a temporary barrier mounted on a flatbed truck in accordance with a non-restrictive illustrative embodiment of the present disclosure;

FIG. 16 is an inner side view of the intermediary post of FIG. 15;

FIG. 17 is an inner side perspective view of the intermediary post of FIG. 15;

FIG. 18 is a perspective inner side view of the intermediary post of FIG. 15 disconnected from the flatbed truck;

FIG. 19 is a perspective outer side and bottom portion view of the intermediary post of FIG. 15 disconnected from the flatbed truck;

FIG. 20 is a perspective outer side and bottom portion view of the intermediary post of FIG. 15 connected to the flatbed truck;

FIG. 21 is an outer side view of a front end post of a temporary barrier mounted on a flatbed truck in accordance with yet another non-restrictive illustrative embodiment of the present disclosure;

FIG. 22 is an outer top, side and rear perspective view of the front end post of a temporary barrier mounted on a flatbed truck of FIG. 21;

FIG. 23 is an outer side view of a front end post of a temporary barrier mounted on a flatbed truck in accordance with still another non-restrictive illustrative embodiment of the present disclosure;

FIG. 24 is an outer top, side and rear perspective view of the front end post of a temporary barrier mounted on a flatbed truck of FIG. 23;

FIG. 25 is an inner side view of a rear end post of a temporary barrier mounted on a flatbed truck in accordance with a further non-restrictive illustrative embodiment of the present disclosure;

FIG. 26 is an inner top, side and rear perspective view of the rear end post of a temporary barrier mounted on a flatbed truck of FIG. 25;

FIG. 27 is an inner side view of a rear end post of a temporary barrier mounted on a flatbed truck in accordance with still a further non-restrictive illustrative embodiment of the present disclosure;

FIG. 28 is an inner top, side and rear perspective view of the rear end post of a temporary barrier mounted on a flatbed truck of FIG. 27;

FIG. 29 is an outer side of a temporary barrier mounted on a flatbed truck in accordance with yet a further non-restrictive illustrative embodiment of the present disclosure showing the front and rear end posts with, the parallel broken lines with zig zags not forming part of the temporary barrier but are shown for illustrative purposes only to represent variable length of the strap member of the temporary barrier and the section of the strap member that is mounted to intermediary posts;

FIG. 30 is an outer, side, top and rea perspective view of the temporary barrier of FIG. 29;

FIG. 31 is an inner side view of a front end post a temporary barrier mounted on a flatbed truck in accordance with yet another non-restrictive illustrative embodiment of the present disclosure;

FIG. 32 is a rear, top and inner side perspective of the front end post of FIG. 31;

FIG. 33 is an outer side view of a front end post a temporary barrier mounted on a flatbed truck in accordance with still yet another non-restrictive illustrative embodiment of the present disclosure;

FIG. 34 is a rear, top and inner side perspective of the front end post of FIG. 33;

FIG. 35 is similar to FIG. 9 yet the mounting assembly is shown showing t without shims in accordance with still yet a further non-restrictive illustrative embodiment of the present disclosure;

FIG. 36 is top, rear and side perspective view of a flatbed truck with a temporary barrier in an open tail configuration accordance with a non-restrictive illustrative embodiment of the present disclosure;

FIG. 37 is top, rear and side perspective view of a flatbed truck with a temporary barrier in a closed tail configuration in accordance with a non-restrictive illustrative embodiment of the present disclosure;

FIG. 38 is a rear and side broken perspective view and of an outer lateral side of the temporary barrier of FIG. 36 or 37 showing the front and rear end posts in accordance with a non-restrictive illustrative embodiment of the present disclosure;

FIG. 39 a rear and side broken perspective view and of an inner lateral side of the temporary barrier of FIG. 38 in accordance with a non-restrictive illustrative embodiment of the present disclosure;

FIG. 40 is side broken view of the outer lateral side of the temporary barrier of FIG. 38 in accordance with a non-restrictive illustrative embodiment of the present disclosure;

FIG. 41 is a front and side perspective view of the rear post of the temporary barrier of FIG. 38 being disassembled from the flatbed truck in accordance with a non-restrictive illustrative embodiment of the present disclosure;

FIG. 42 is a bottom perspective view of the rear post of FIG. 41 in accordance with a non-restrictive illustrative embodiment of the present disclosure;

FIG. 43 is a front perspective view and of an outer rear side of the temporary barrier in the closed tail configuration of o37 showing the rear end posts of each lateral side in accordance with a non-restrictive illustrative embodiment of the present disclosure;

FIG. 44 is a sectional view of a post member of the front and rear posts of the temporary barrier of FIG. 38 in accordance with a non-restrictive illustrative embodiment of the present disclosure;

FIG. 45 is a perspective top and side view of a plurality of pocket size gases in accordance with a non-restrictive illustrative embodiment of the present disclosure;

FIG. 46 is a rear and side broken perspective view of an inner lateral side and outer rear side of a temporary barrier showing front and rear end posts thereof in accordance with a non-restrictive illustrative embodiment of the present disclosure;

FIG. 47 is a rear and side broken perspective view of an inner latera side, an outer rear side and an outer lateral side of a temporary barrier showing rear end posts thereof in accordance with a non-restrictive illustrative embodiment of the present disclosure;

FIG. 48 is a front and side broken perspective view of an inner lateral side, an inner rear side and an outer lateral side of a temporary barrier showing rear end posts thereof in accordance with a non-restrictive illustrative embodiment of the present disclosure;

FIG. 49 is a front and side broken perspective view of an inner rear side and an inner lateral side of temporary barrier showing a rear end post thereof in accordance with a non-restrictive illustrative embodiment of the present disclosure;

FIG. 50 is a side broken view of an outer lateral side of a temporary barrier showing front and rear end posts thereof in accordance with a non-restrictive illustrative embodiment of the present disclosure;

FIG. 51 is a partial side view of an outer lateral side of a temporary barrier showing an intermediate post thereof in accordance with a non-restrictive illustrative embodiment of the present disclosure;

FIG. 52 is a partial side view of an inner lateral side of a temporary barrier showing an intermediate post thereof in accordance with a non-restrictive illustrative embodiment of the present disclosure;

FIG. 53 is an inner side and rear perspective view of the intermediate post of FIGS. 51 and 52 in accordance with a non-restrictive illustrative embodiment of the present disclosure;

FIG. 54 is an enlarged inner side and rea perspective view of a bottom portion of the intermediate post of FIG. 53 in accordance with a non-restrictive illustrative embodiment of the present disclosure;

FIG. 55 is an enlarged view of a bottom portion of the intermediate post of FIG. 51 in accordance with a non-restrictive illustrative embodiment of the present disclosure;

FIG. 56 is a sectional view of a bottom portion of the intermediate post member of FIG. 53 showing the internal mounting assembly thereof in a pocket disengagement or releasing position; and

FIG. 57 is the sectional view of FIG. 56 showing the internal mounting assembly thereof in a pocket engagement or locking position.

### DETAILED DESCRIPTION OF ILLUSTRATIVE EMBODIMENTS

Generally stated and in accordance with an embodiment, there is provided a temporary barrier for a flatbed of a truck. The flatbed comprises a frame structure with a platform extending therein and defining front and rear ends thereof. The frame structure further defines outer sides extending along and downwardly of the platform. The outer sides comprise pockets having top and bottom openings. The temporary barrier comprises front and rear end posts, each including a respective elongate vertical member having a bottom portion configured to be placed within a corresponding one of the pockets. The front and rear end posts further comprise respective end post mounting assemblies for mounting the bottom portions of the end post elongate vertical members to the pockets. The temporary barrier further comprises intermediate posts, each including a respective elongate vertical member having a bottom portion configured to be placed within a corresponding one of the pockets. The intermediate posts further comprise respective intermediate post mounting assemblies for mounting the bottom portions of the intermediate post elongate vertical members to the pockets. A strap structure is mounted to the front and rear end posts and to the intermediate posts.

With reference to the appended Figures, non-restrictive illustrative embodiments will be herein described so as to further exemplify the disclosure only and by no means limit the scope thereof.

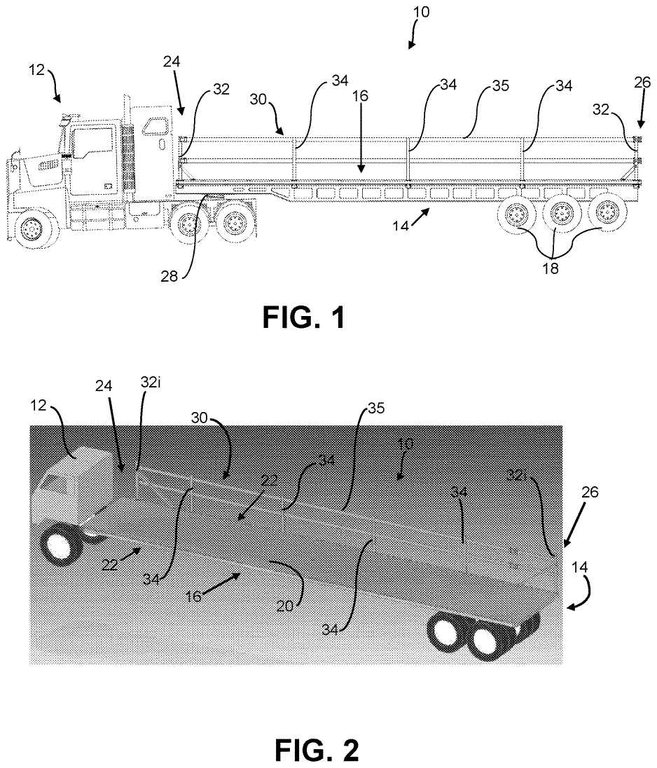

FIGS. 1 and 2 show a flatbed truck 10 comprising the truck cabin body 12 and a flatbed trailer 14 hitched to the truck cabin body 12. The flatbed trailer 14 includes a flatbed 16 with rear wheels 18 rotatably mounted thereto. The flatbed 16 comprises a flatbed platform 20 and defines opposite lateral sides 22 and front and rear ends 24 and 26 respectively. The flatbed 16 also includes an underside front hitch 28 for being hitched to the truck cabin body 12.

A temporary barrier 30 is mounted to the flatbed 16 such that it provides barrier about the lateral side 22 and rear end 26. The temporary barrier 30 includes front and rear end post generally denoted 32 and intermediate posts 34 all of which are interconnected by a barrier strap structure 35 as will be further described hereinbelow. With particular reference to FIG. 2, it should be noted that the term “front” and “rear” when referring to end posts herein are interchangeable as a given end post 32 is considered a front end post 32i when positioned at the front end 24 of the flatbed 16 and is considered a rear end post 32ii when positioned at the rear end 26 of the flatbed 16.

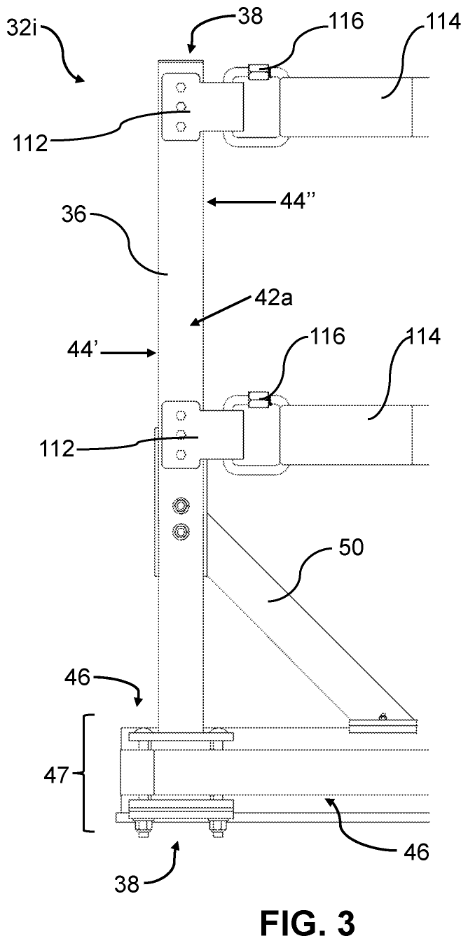

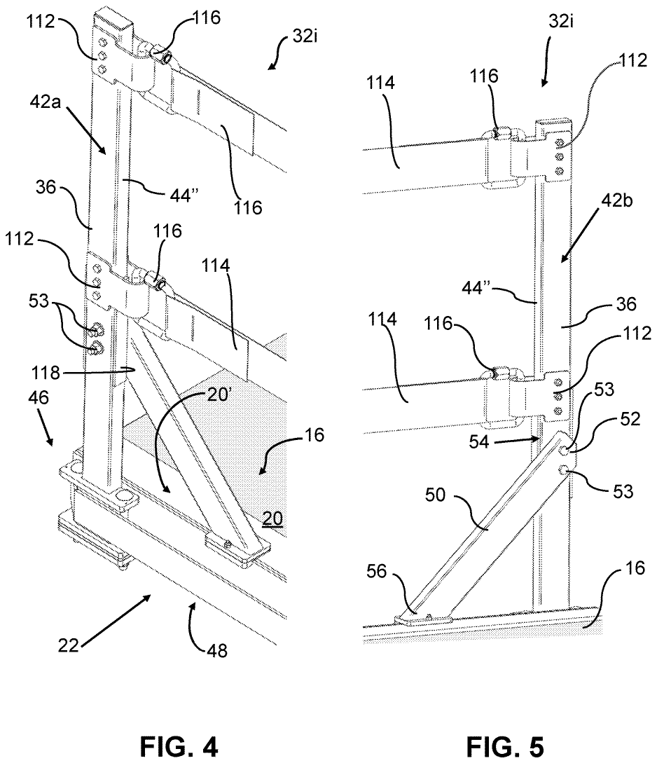

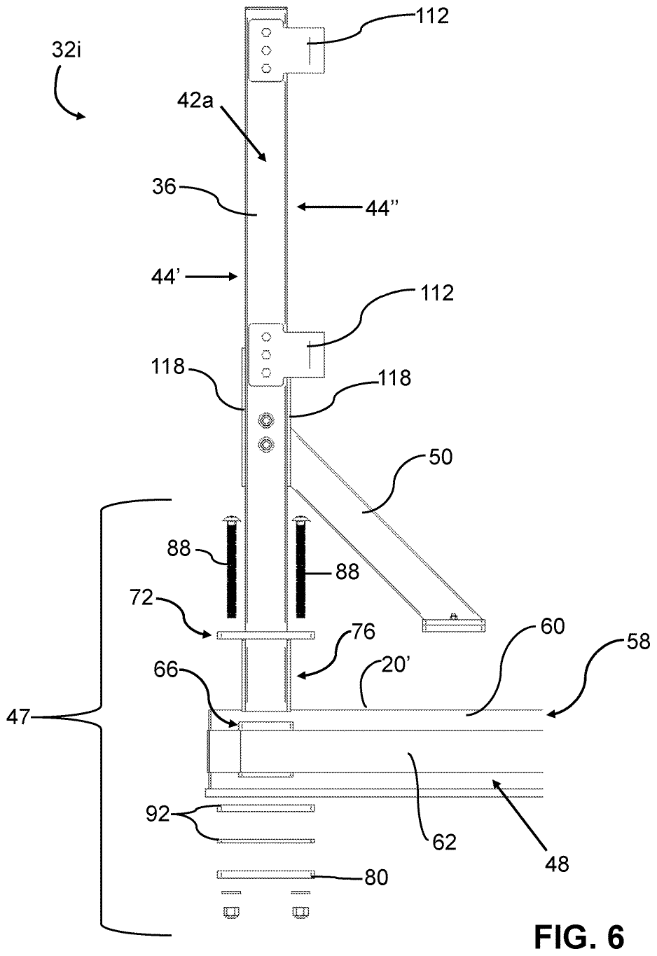

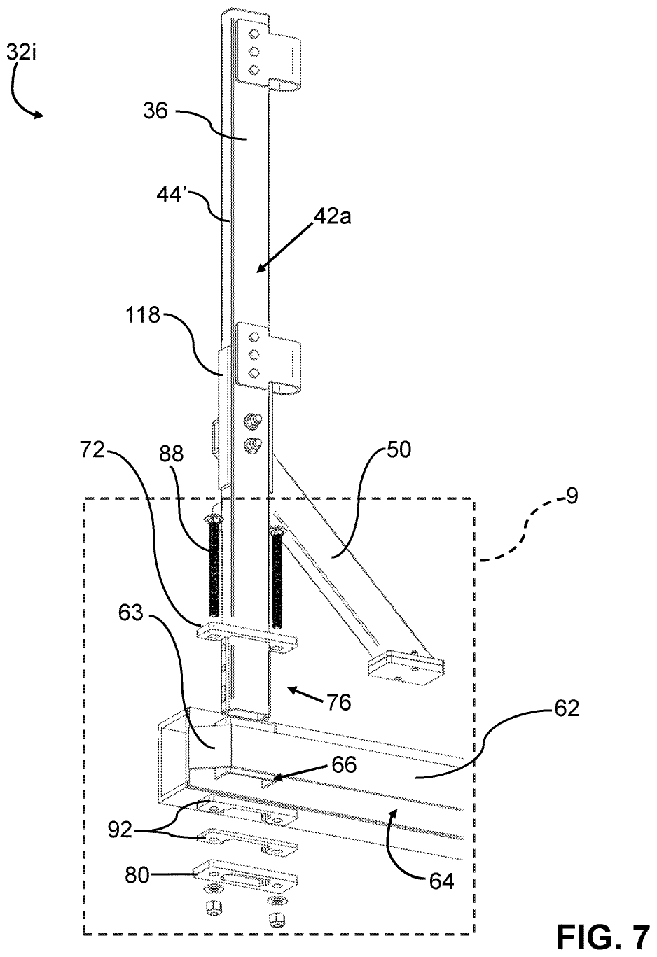

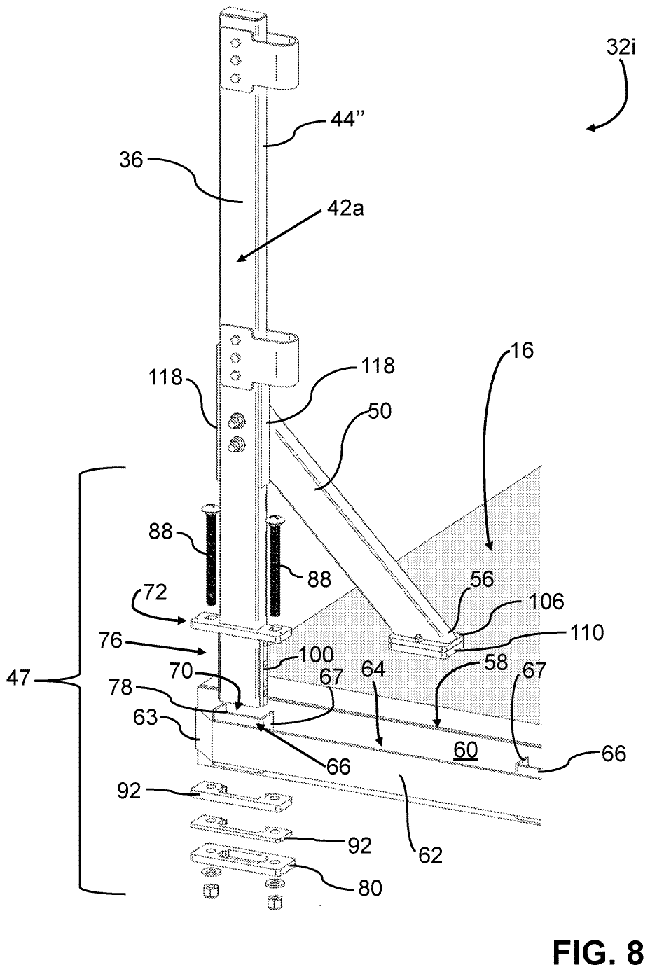

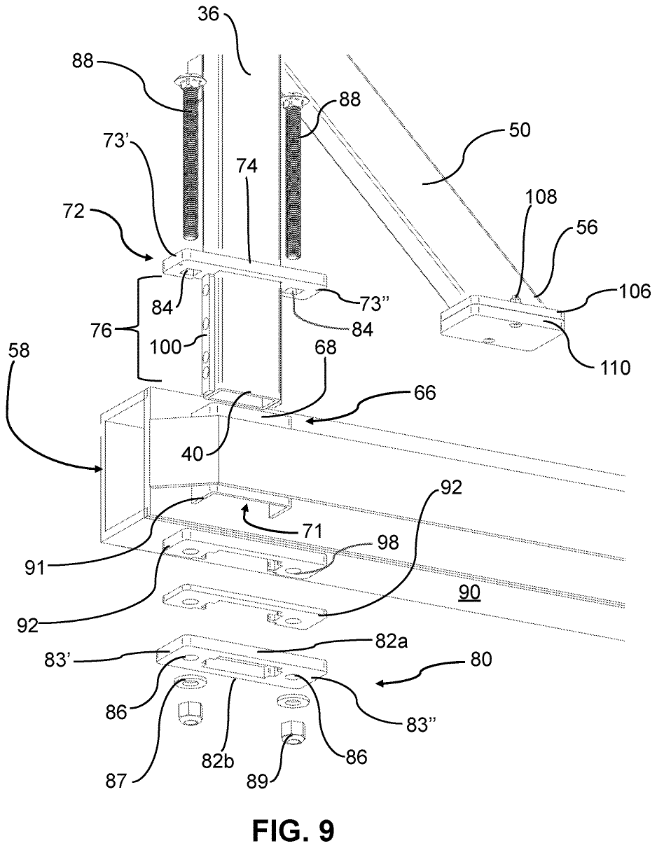

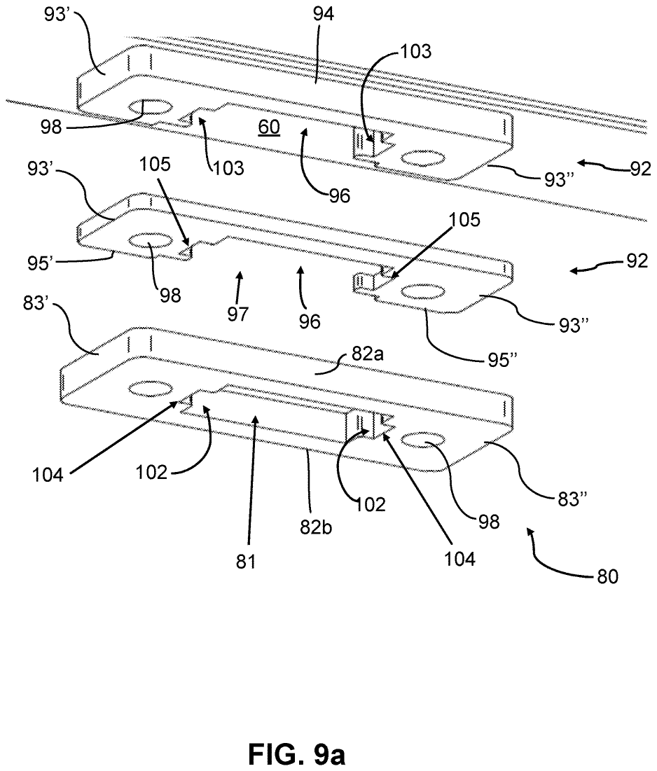

FIGS. 3 to 5 show a front end post 32i in accordance with a non-restrictive illustrative embodiment mounted to the flatbed 16. FIGS. 6 to 9a show the front end post 32i disconnected from the flatbed 16 and partially disassembled.

The end post 32i comprises a vertical post member 36 defining top and bottom ends, 38 and 40 respectively, outer and inner lateral sides 42a and 42b, respectively and front and rear sides 44′ and 44″, respectively. The terms “front” and “rear” sides are interchangeable as they depend on whether the post member is on the left or right lateral side 22 of the flatbed 16 and thus sides 44′ and 44″ can also be referred to so as first and second sides or spacer sides between the outer and inner lateral sides 42a and 42b. The bottom end 40 of the post member 36 comprises a mounting assembly 46 for being mounted to an outer part 48 of the lateral side 22 of the flatbed 16. The end post 32i comprises a brace member 50 connected at a top end 52 thereof to mid lower section 54 of the post member 36 at the inner side 42b of the post member 36 via fasteners 53 such as bolts for example. The brace member 50 diagonally extends from the mid lower section 54 of the post member to the flatbed 16. The bottom end 56 of the brace member 50 is connected to the flatbed platform 20 near the lateral side 22.

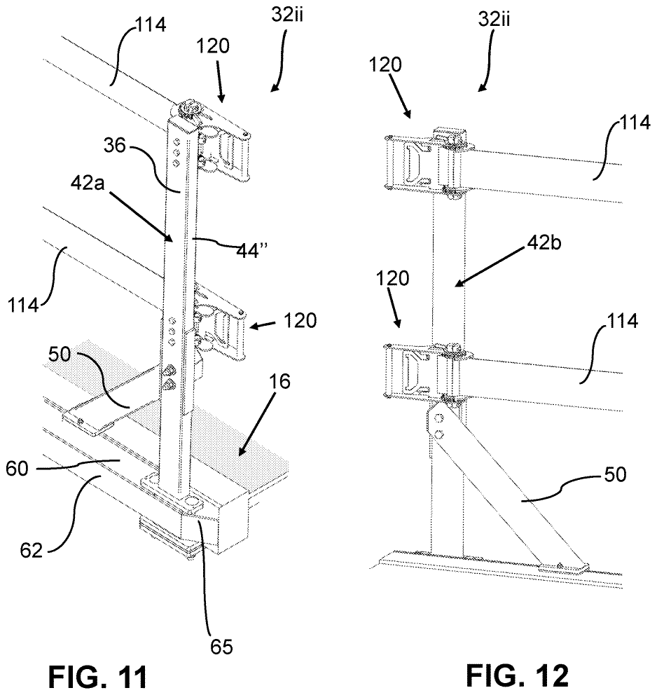

The flatbed 16 includes a rectangular frame structure 58 at each lateral side 22 thereof defining the outer part 48 of the lateral side and defining a top frame part 20′ forming part of the flatbed platform. It is this outer part 48 and this top frame part 20′ that receive the end post 32i for connection therewith. The outer part 48 comprises an outer frame panel 60 with an outer runner 62 outwardly protruding therefrom and running along the length of the frame panel 60 to define a space 64 therebetween. The outer runner 62 has a front end 63 and a rear end 65 (see FIG. 11) diagonally extending from the frame panel. Pockets 66, such as stake pockets, extend from the frame panel 60 and are positioned within the space 64 between the frame panel 60 and the outer runner 62. The pockets 66 have rectangular body defining side panels 67 and a front panel 68 defining top and bottom openings 70 and 71 respectively.

The mounting assembly 46 comprises a clamping structure 47 including a top flange plate 72 with front and rear parts 73′ and 73″ protruding from the front and rear sides 44′ and 44″ of the post member 36 respectively and an outer plate part 74 protruding from the post outer side 42a with the inner side 42b of the post member 36 remaining flat to flushingly engage the frame panel 60. The lower section 76 of the post member 36 extending directly beneath the plate 72 towards the bottom end 40 is fitted within a pocket 66. The plate 72 engages the top rim 78 of the pocket 66 that circumscribing the top opening 70 and that acts as a stopper for the post member 36.

The bottom end 40 of the post member 36 along with a bottom most portion of the lower section 76 extends outwardly of the bottom pocket opening 71 and is fitted within a bottom plate 80. The bottom plate 80 defines a rectangular opening 81 complementarily configured so as to receive the lower section 76 of the post member 36 therein. The bottom plate 80 defines outer and inner parts, 82a and 82b and front and rear parts 83′ and 83″. The front and parts 73′ and 73″ of the top plate 72 include respective holes 84 which are aligned with the respective holes 86 of the front and rear parts 83′ and 83″ of the bottom plate 80 for mutual connection via fasteners 88. In an embodiment, the fasteners 88 are threaded bolts with nuts 87 and washers 89. When interconnected to the top plate 72, the inner part 82b of the bottom plate 80 engages the undersurface 90 of the frame structure thereby clamping the lower section 76 of the post member 36 to the flatbed 16.

In certain instances, the bottom plate 80 stabilizing support plates, such as shims 92 are required for the gap along the lower section 76 of the post member 36 between the bottom plate 80 and the bottom rim 91 of the pocket 66 circumscribing the bottom opening 71. One or more shims 92 of various sizes are used to fill this gap and provide greater clamping support and stability. Each shim 92 has a bracket like structure with an outer part 94, flanked by front and rear parts 93′ and 93″ defining respective inner ends 95′ and 95″, the shim 92 defines a C-shaped central opening 96 defining an inner opening 97 at the inner side of the shim 92 between inner ends 95′ and 95″. The inner ends 95′ and 95″ engage the outer surface 42a of the lower section 76 of the post member 36 thereby closing the opening 97. The lower section 76 is fitted through the pocket 66, the shim openings 96 and the bottom plate opening 81. The shims 92 are sandwiched between the bottom rim 91 of the pocket 66 and the bottom plate 80. The front and rear ends 93′ and 93″ of the shims 92 have respective holes 98 aligned with holes 84 and 86 of the top and bottom plates 72 and 80, respectively for receiving the bolts 88 therethrough for fastening thereof.

The front and rear ends 44′ and 44″ of the lower section 76 of the post member 36 comprise respective protruding rails 100 for being fitted within respective grooves 102 in the front and rear inner lateral walls 104 of the bottom plate 80 circumscribing the opening 81. Similarly, the rails 100 are also fitted into similar respective grooves 103 in the front and rear inner walls 105 of the shims 92 circumscribing their openings 96. In this way the rails 100 are locked within grooves 102 and 103 preventing the lower section 76 of the post member 36 from pivoting about its longitudinal axis.

The bottom end 56 of the brace member 50 comprises a plate 106 for being fastened via fasteners 108 is connected to the top end 20′ of the frame structure 58. Any gaps between the plate 106 and the top end surface 20″ can be filled by plate shims plates 110.

The post member 36 includes connectors 112 at predetermined positions along its vertical length extending from their front or rear ends 44′ or 44″. In this example, the connectors 112 provide being connected to strap members 114 via quick links 116.

The front and rear ends of the post members 36 include reinforcement bars 118 which avoid buckling of the post member 36 under heavy loads.

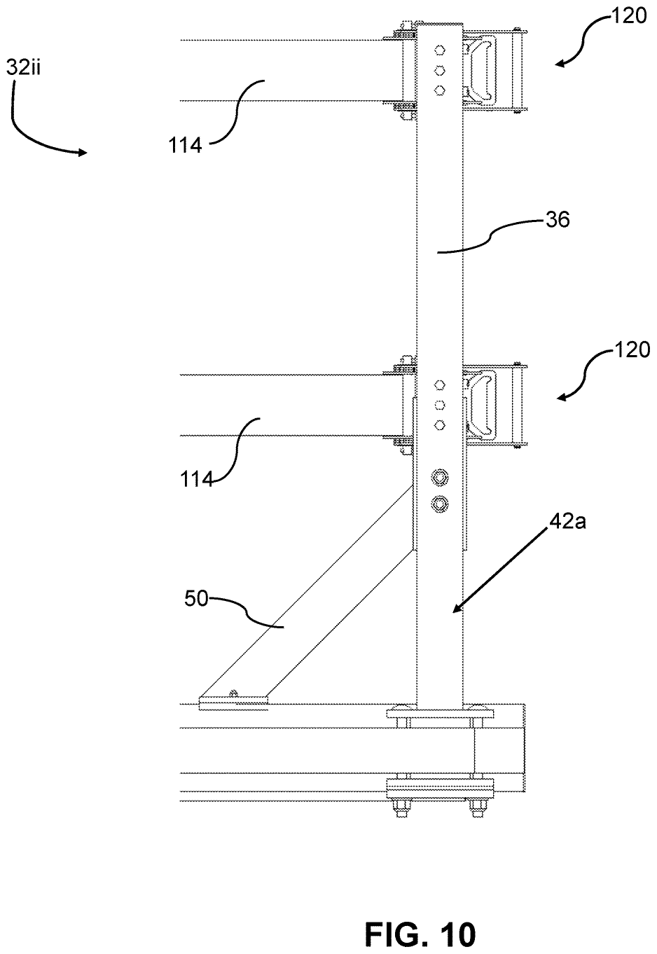

FIGS. 10 and 11 show a rear end post 32ii that is similarly constructed as the front end post 32i with the exception of the orientation of the brace member 50. In this example, the end post 32ii is shown having ratchet connectors 120 instead of connectors 112 for connecting strap members 114 thereto. In this example, the ratchet connectors 120 are short handle ratchets which provide for less tension on the post member 36.

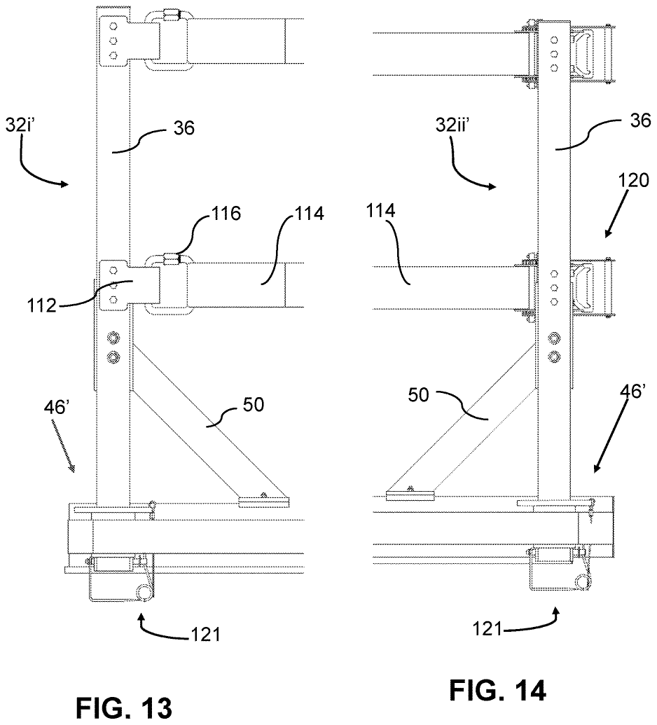

With reference to FIGS. 13 and 14 respectively shown a front end post member 32i′ and a rear end post 32ii′. The difference between the end posts 32i′, 32ii′ and the end posts 32i, 32ii described above is the mounting assemblies 46′ comprise a pin structure 121 instead of a clamping structure 47. The pin structure 121 is easier to remove. In most cases, the end posts 32 will use clamping structure 47 as they will remain in place and not be removed. Pin structure 121 mounting assemblies are more convenient for intermediary posts 34 as these posts are more often removed when adding or removing cargo. Pin structure 121 will be further described below with reference to the intermediary posts 34.

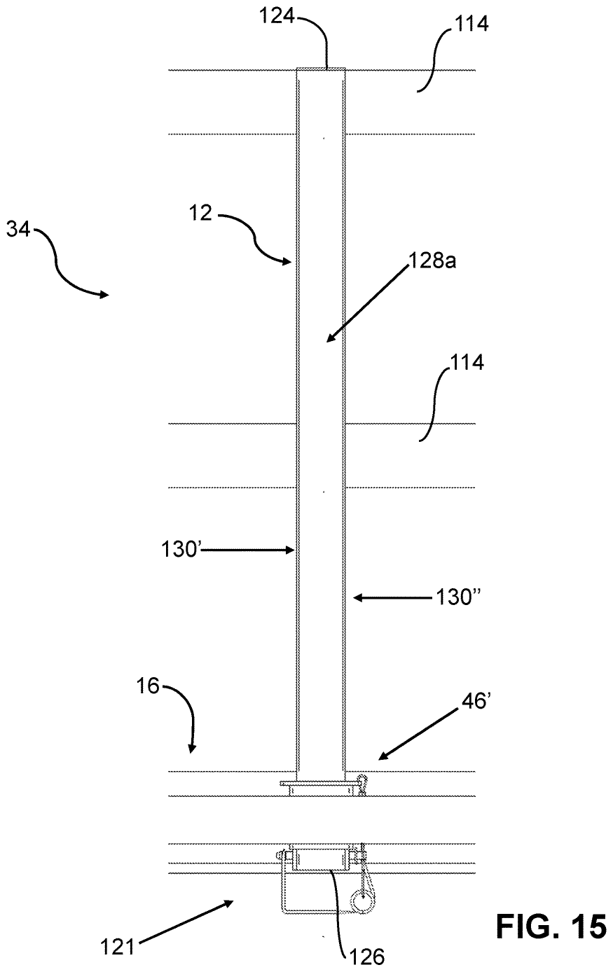

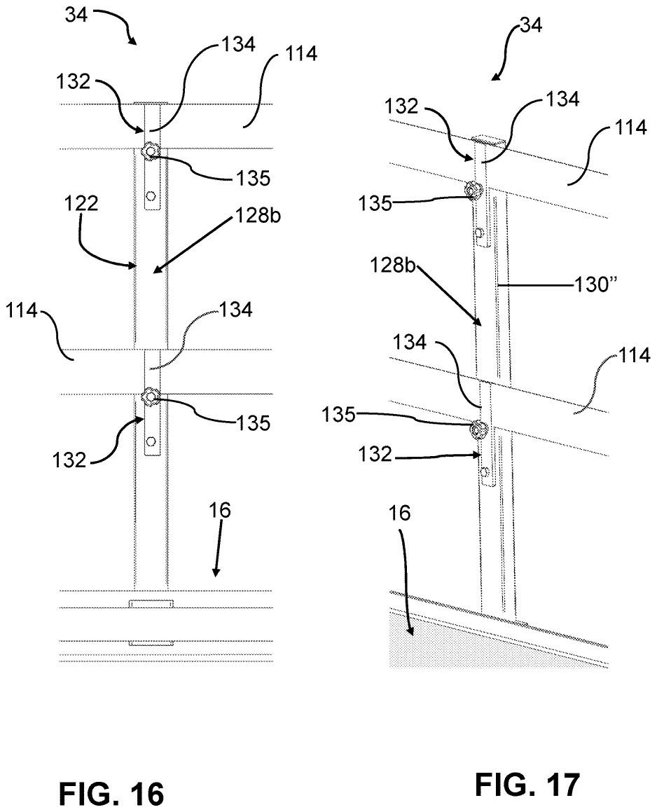

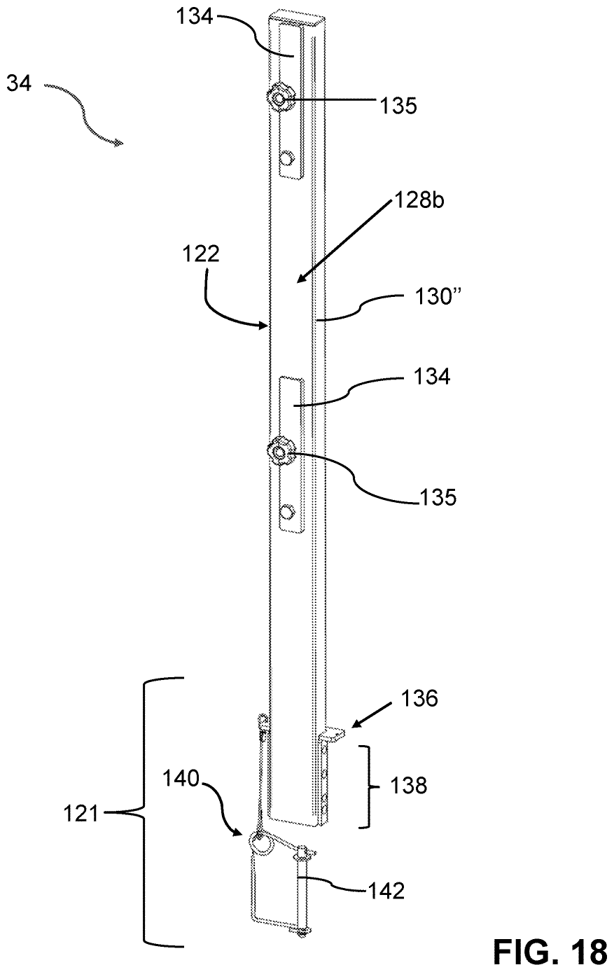

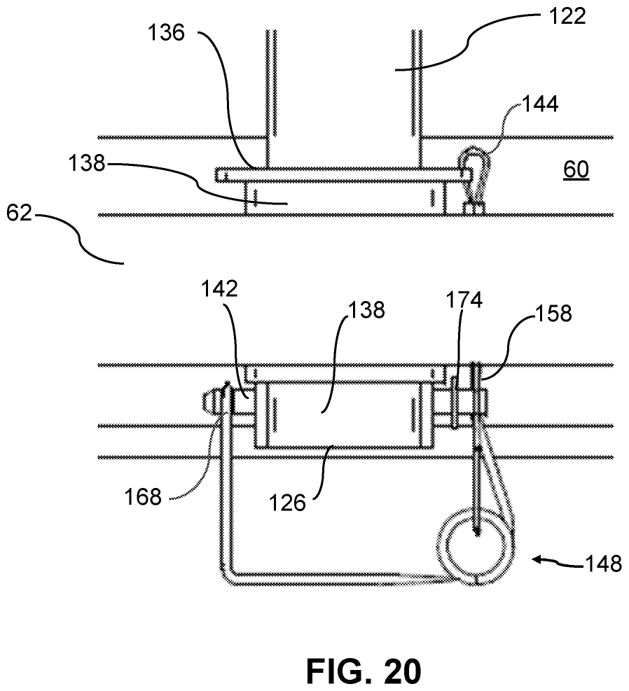

With reference to FIG. 15 to 16 and 20, there is shown an intermediary post 34 connected to the flatbed 16. The elongate post 34 is shown disconnected from the flatbed 16 in FIGS. 17 to 20.

The intermediary post 34 comprises elongate body 122 defining top and bottom ends, 124 and 126, outer and inner lateral sides 128a and 128b and front and rear sides 130′ and 130″. The terms “front” and “rear” sides are interchangeable as they depend on whether the elongate body 122 is on the left or right lateral side 22 of the flatbed 16 and thus sides 130′ and 130″ can also be referred o so as first and second sides or spacer sides between the outer and inner lateral sides 128a and 128b. The inner side 128b includes clamps 132 for clamping a strap member to the intermediary post 34. In this example, the clamp 134 includes an elongate clamp member that be released or tightened onto the inner side 122b via an adjustment knob 135.

The intermediary post 34 includes a mounting assembly 46′ at its bottom end 126 comprising a pin structure 121. Structure 121 comprises a top flange plate 136 with first and second parts 133′ and 133″ protruding from the first and second sides 130′ and 130″ of the elongate body 122 respectively and an outer plate part 137 protruding from the outer side 128a with the inner side 128 of the elongate remaining flat to flushingly engage the frame panel 60. The lower section 138 of the elongate body 122 extending directly beneath the plate 136 towards the bottom end 126 is fitted within a pocket 66. The plate 134 engages the top rim 78 of the pocket 66 that circumscribing the top opening 70 and that acts as a stopper for the elongate body.

The first and second parts 133′ and 133″ have holes 139 for receiving a bail 140 carrying a pin 142. The bail 140 includes a wire 143 with one loop 144 connected to the first or second parts 133′, 133″ via the holes 139 and a second loop 146 connected t o a spring 148 carrying the pin 142. The spring has a loop 152 connected to the second loop 146 and rear and front arms 154 and 156 extending from the loop 152. The rear arm 154 linearly extends from the loop 152 and defines a bent free end 158 connected to a rear end 160 of the pin 142 via a hole 162 therethrough. The front arm 154 linearly extends from the loop 152 and is redirected at an elbow 164 towards a free end hook 168 that is hooked on a front threaded portion 170 of the pin 142. The user removes the hook 168 from the pin 142 and passes the pin through the lower section 136 of the elongate body 122 via pairs of opposite apertures 172 aligned at the first and second sides 130′ and 130″. The pin 142 has a stopper 174 near its rear end 160 stopping the pin from further passing through the apertures 172 at side 130″ whereas the hook 168 stops the pin 142 from further through the apertures 172 a side 130′ thereby maintaining the pin in place and releasably locking the intermediary post member 34 to the flatbed 16.

The strap structure 35 comprises a plurality of strap member 114 connected to posts 32 and 34 as provided herein. The pin structures 121 are quickly removed to partially, substantially or fully remove the temporary barrier 30 from the flatbed 16 during loading or unloading of cargo providing a fast to assemble and disassemble, secure temporary barrier 30 for flatbed trucks 10.

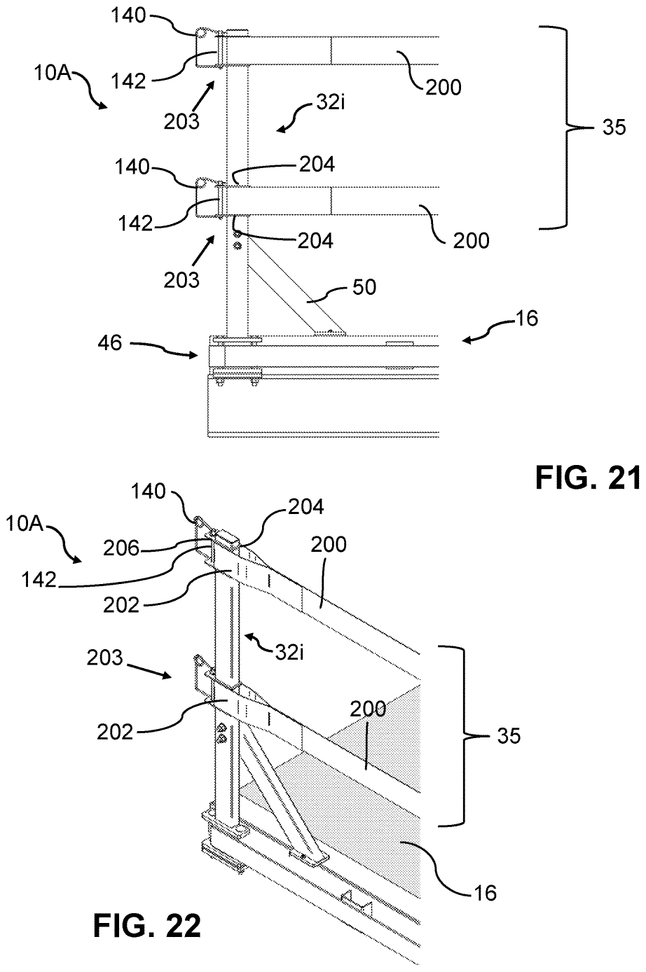

FIGS. 21 and 22 show a temporary barrier 10A having a strap structure 35 comprising first and second strap members 200 having respective loops 202 for being looped onto a front end post 32i and kept in place via first and second stopper sections 203 each having top and bottom plates 204 having respective front portions 206 with holes to receive a pin 142 connected to a bail 140 as that used in pin structure 121 thereby locking the loop 202 within a section 203.

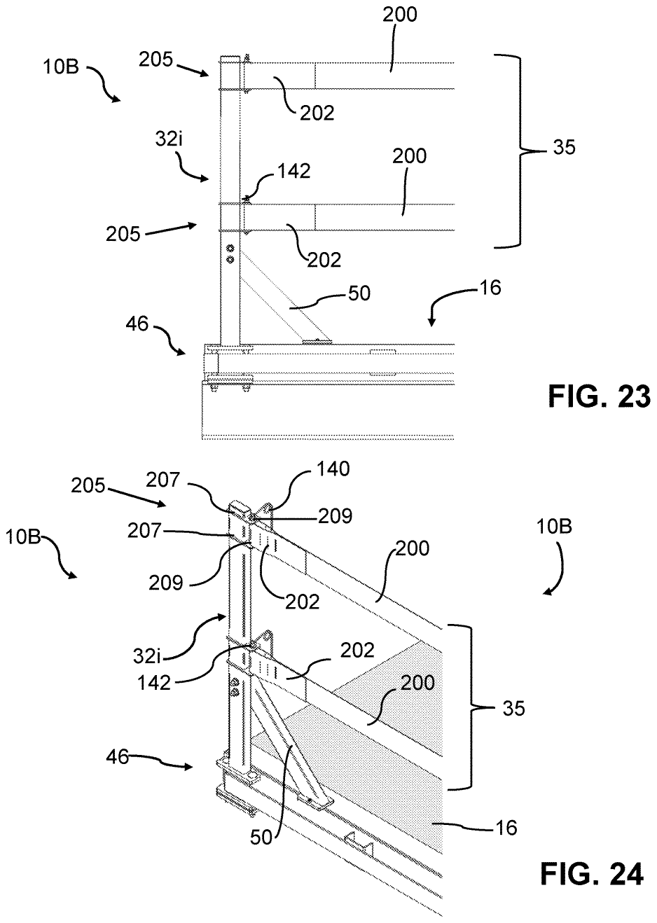

FIGS. 23 and 24 show a temporary barrier 10B having a strap structure 35 comprising first and second strap members 200 having respective loops 202 for being looped onto a pin 142 positioned on a front end post 32i and kept in place via first and second stopper sections 205 each having top and bottom plates 207 having a respective front portion 209 with holes to receive the pin 142 connected to a bail 140 as that used in pin structure 121 thereby locking the loop 202 within a section 205.

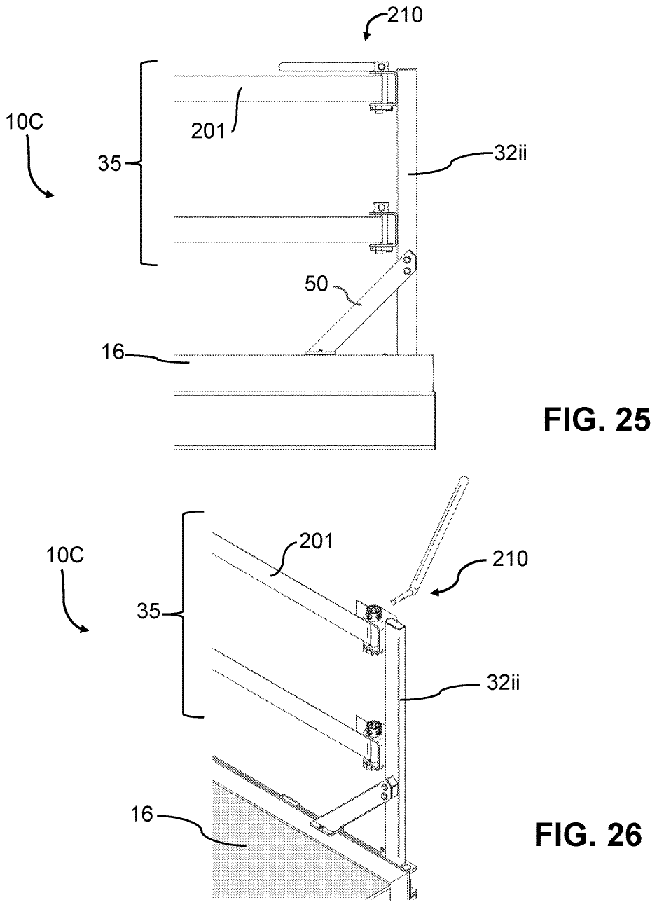

FIGS. 25 and 26 show a temporary barrier 10C having a strap structure 35 comprising a strap member 201 mounted to a rear end post 32ii via a trailer winch 210.

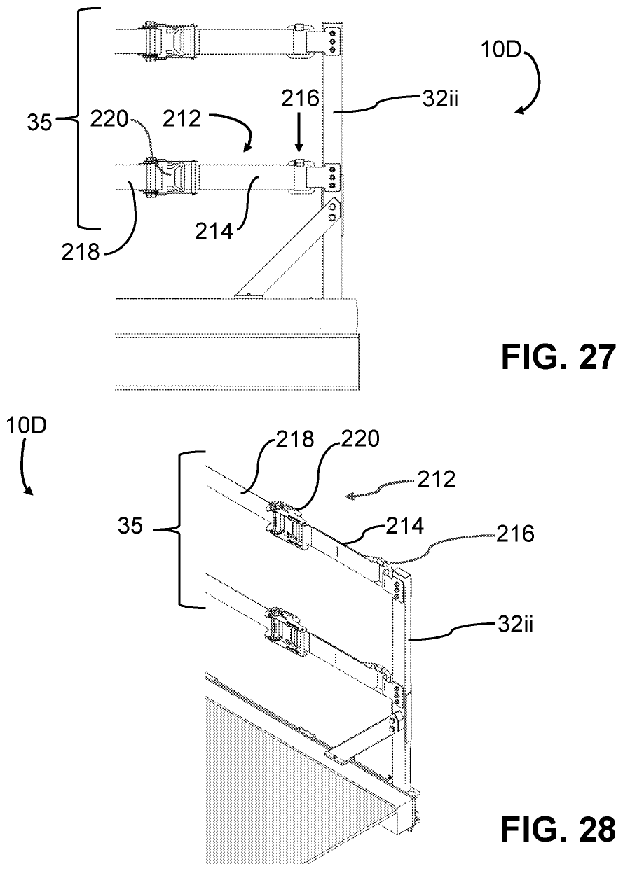

FIGS. 27 and 28 show a temporary barrier 10D having a strap structure 35 comprising a ratchet strap 212. The ratchet strap 212 comprises a short end strap member 214 connected to a rear end post 32ii via a quick link 216 and connected to a longer strap member 218 via a ratchet 220.

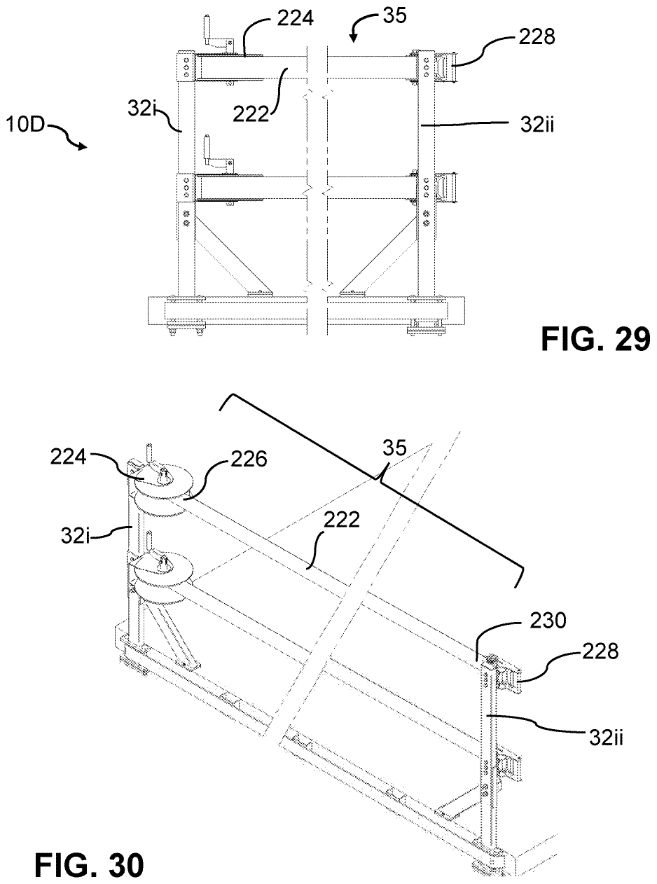

FIGS. 29 and 30 show a temporary barrier 10E having a strap structure 35 comprising a strap member 222 comprising a tensioning ratchet 224 mounted to a front end post 32i at one end 226 thereof and further comprising a ratchet 228 mounted to a rear end post 32ii at another end 230 thereof.

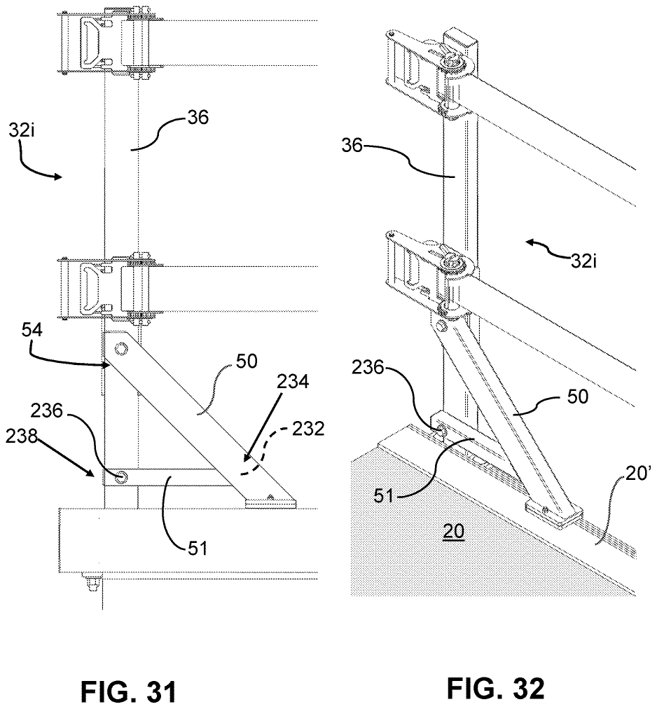

FIGS. 31 and 32 show a front end post 32i with the brace member connected to a mid-lower section 54 of the post member 36 at the inner side 42b of the post member 36 and extending rom the mid lower section 54 of the to the flatbed 16 being mounted on the frame top surface 20′. In the example, a horizontal stabilizing support member 51 is mounted at one end 232 to the bottom part 234 of the brace 50 and at another ends 236 thereof to a bottom part 238 of the post member 36 providing stability to the brace 50 which provides stability to the post member. The support member 51 thus extends above and along the platform surface 20 of the flatbed 16.

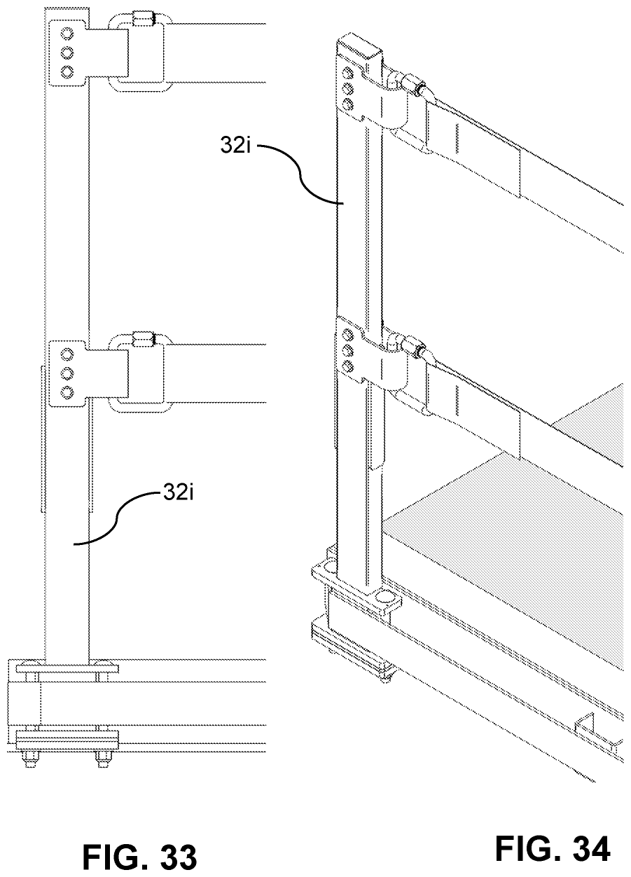

In an embodiment and as shown in FIGS. 33 and 34, the end post 32i does not require a brace member 50.

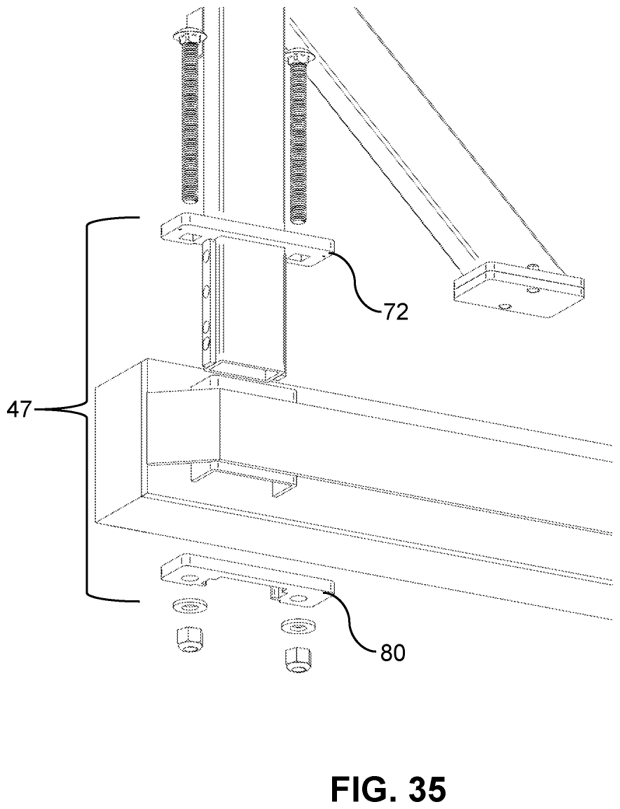

In an embodiment and a shown in FIG. 35, the clamping structure 47 does not require shims 92 between the top plate 72 and the bottom plate 80.

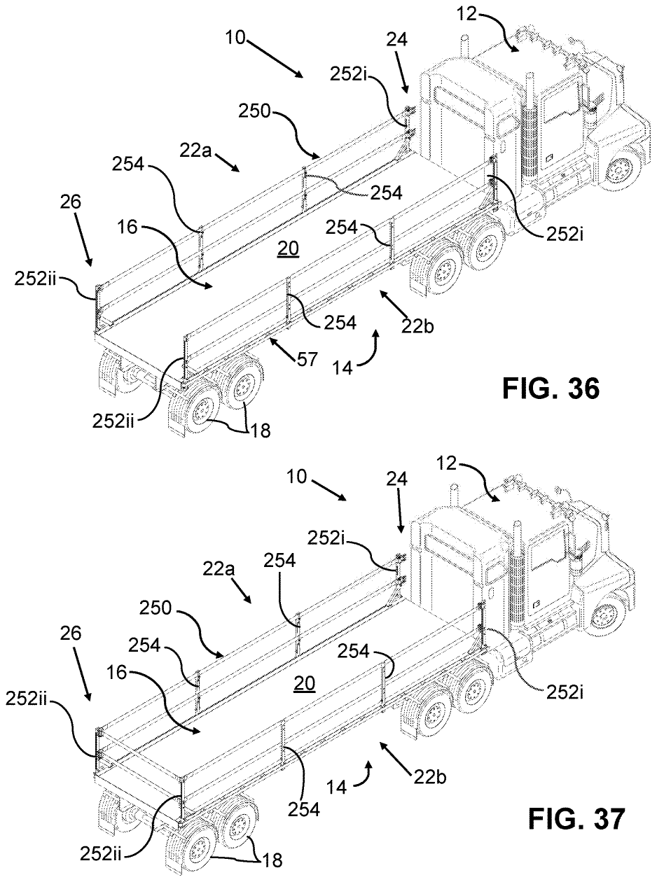

FIGS. 36 and 37 show the flatbed truck 10 of FIGS. 1 and 2 comprising the truck cabin body 12 and the flatbed trailer 14 hitched to the truck cabin body 12. The flatbed trailer 14 includes the flatbed 16 with rear wheels 18 rotatably mounted thereto. The flatbed 16 comprises the flatbed platform 20 and defines opposite lateral sides 22a, 22b and front and rear ends 24 and 26 respectively.

A temporary barrier 250 is mounted to the flatbed 16 such that it provides a barrier about one or both lateral sides 22a, 22b as well as the rear end 26 when in a closed tail configuration as shown in FIG. 37. FIG. 36 shows the temporary barrier 250 in an open tail configuration when the rear end 26 is left open.

The temporary barrier 250 includes front end posts 252i mounted at the front end 24 of the flatbed 16 at each lateral side 22a and 22b thereof and rear end posts 252ii mounted at the rear end 26 of the flatbed 16 at each lateral side 22a, 22b thereof. Midway or intermediate posts 254 are mounted to the lateral sides 22a and 22b between the front and rear end posts 252i and 252ii. The posts 252i, 254ii and 254 provide for carrying the strap structure 35.

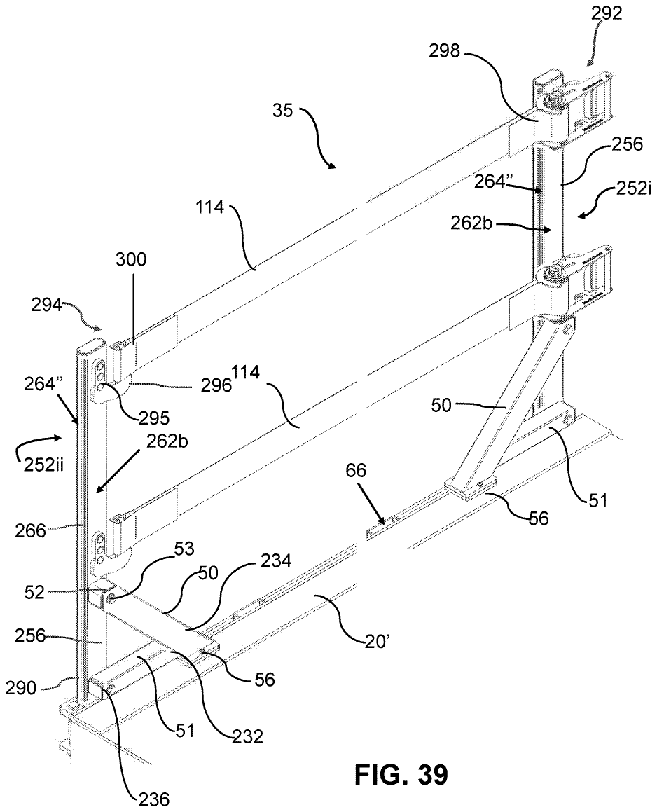

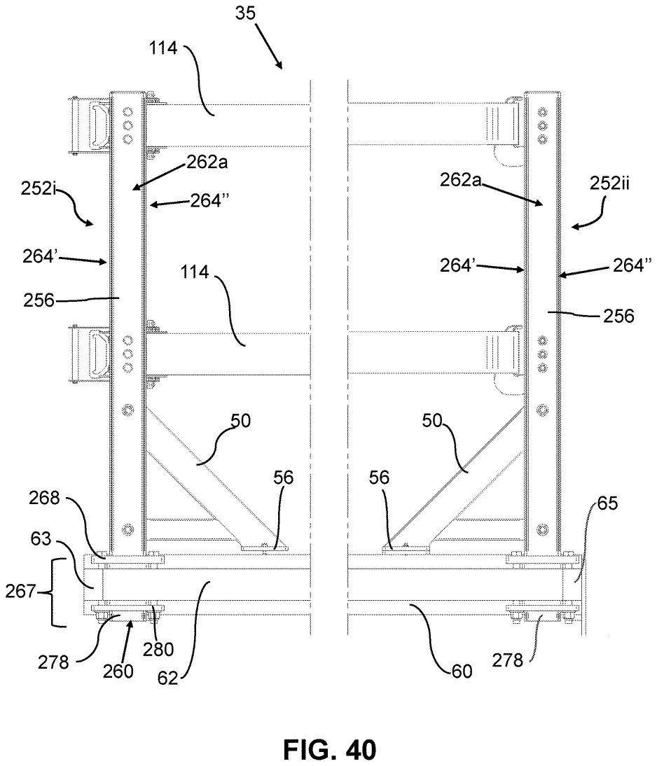

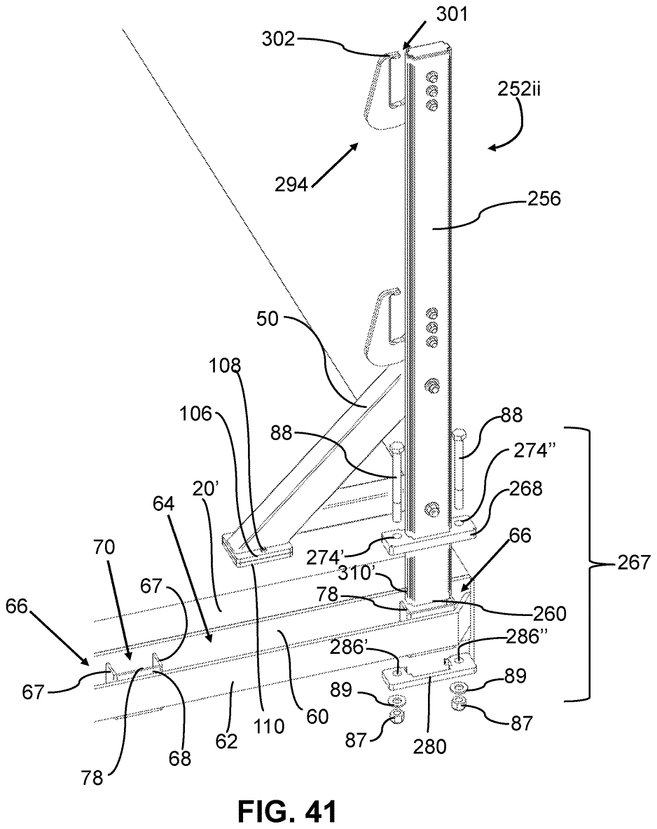

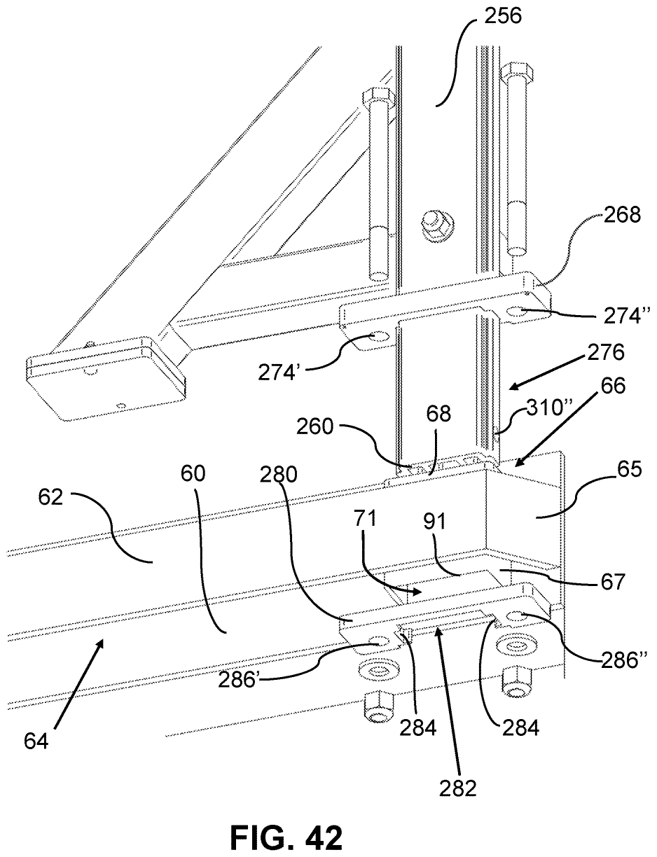

As shown in FIGS. 36 to 42, the flatbed 16 comprises a frame 57 with lateral frame structures 58 at each lateral side 22a and 22b. The frame structure 58 defines a top frame part 20′ and an outer frame panel 60 with an outer runner 62 outwardly protruding therefrom and running along the length of the frame panel 60 to define a space 64 therebetween. The outer runner 62 has a front end 63 and a rear end 65 diagonally extending from the frame panel 60. Pockets 66 (such as stake pockets) extend from the frame panel 60 and are positioned within the space 64 between the frame panel 60 and the outer runner 62. With particular reference to FIGS. 41 and 42 The pockets 66 have rectangular body defining side panels 67 and a front panel 68 defining top and bottom openings 70 and 71 respectively.

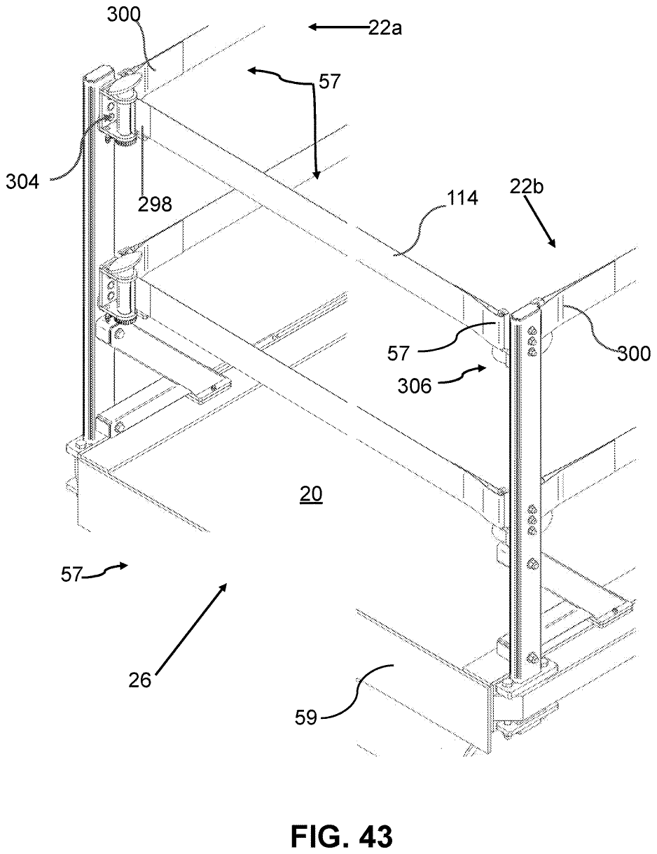

As better shown in FIG. 43, the frame 57 defines a rear frame panel 59.

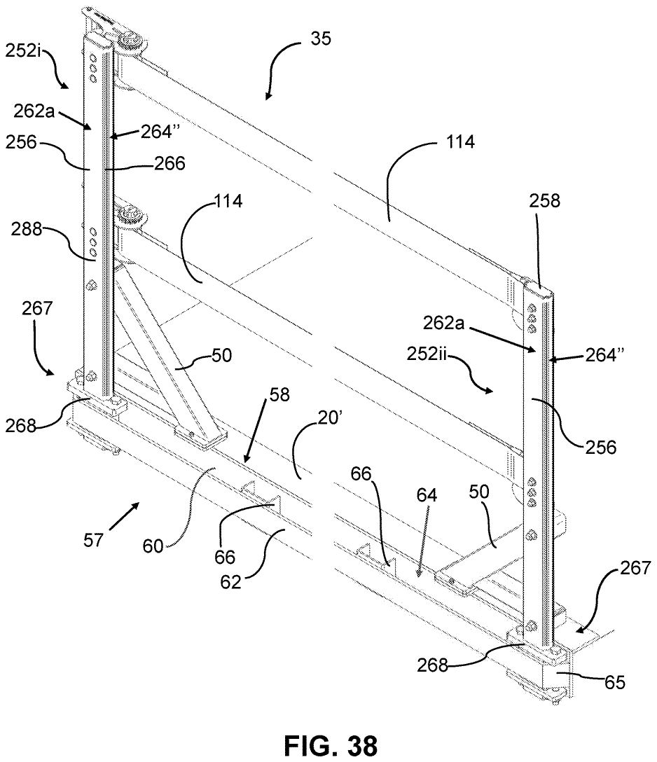

With reference to FIGS. 38 to 42, there is shown the front and rear end posts 252i and 252ii. Each post 252i, 252ii comprises a vertical post member 256. Depending on the positioning of post member 256 on the flatbed 16 it defines top and bottom ends, 258 and 260, outer and inner lateral sides 262a and 262b, and front and rear sides 264′ and 264″, respectively.

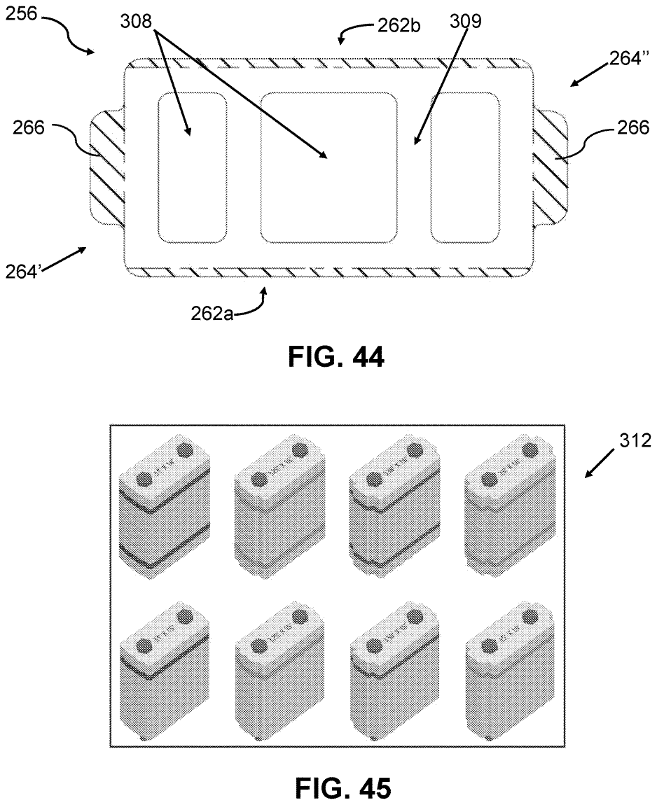

With reference to FIG. 44, the post member 256 defines protruding rails 266 along its front and rear sides 264′ and 264″ which can be filed down as will be further explained below. The lateral sides 262a and 262b can also be filed down as will also be further explained below.

Returning to FIGS. 38 to 42, the front and rear end posts 252i and 252ii comprise a mounting assembly 267 for being mounted to the flatbed 16. The mounting assembly comprises a top flanged plate 268 extending from the front and rear sides 264′ and 264″ and the outer side 262a of the post member 256. The plate 268 provides front and rear holes 274′ and 274″. In an embodiment, the plate 268 is integral to the post member 256. In an embodiment, the plate 256 is mounted to the post member 256.

The post member defines a lower section 276 thereof extending beneath the plate 268 and leading to the bottom end 260. This lower section 276 is inserted within the pocket 66 via the top opening 70 with the plate 268 engaging the top rim 78 of the pocket 66 to be stopped thereby providing a bottommost portion 278 of the lower section 276 near the bottom end 260 to outwardly extend from the bottom opening 71 of the pocket 66.

The mounting assembly 267 comprises a bottom plate 280 with a central open channel 282 for receiving the portion 278 therein and providing front and rear notches 284 for receiving the protruding rails 266 therein. The plate 280 defines front and rear holes 286′ and 286″ which are aligned with holes 274′ and 274″ respectively for receiving bolts 88 therethrough for fastening the plates 268 with nuts 87 and washers 89 thereby clamping the post members 256 to the frame 57 of the flatbed 16 as the bottom plate 280 engages the bottom rim 91 of the pocket 66 and is stopped thereby.

With continued reference to FIGS. 38 to 42, the end posts 252i and 252ii comprise respective brace members 50 connected to a top end 52 thereof to a mid lower section 288 of the post member 256 at the inner side 262b thereof via fasteners 53. The brace member 50 diagonally extends from the mid lower section 288 of the post member 256 to the flatbed 16. The bottom end 56 of the brace member 50 is connected to the top frame part 20′. A horizontal stabilizing support member 51 is mounted at one end 232 to the lower part 234 of the brace 50 and at another end 236 thereof to a lower part 290 of the post member 256 providing stability to the brace 50 which provides stability to the post member. The support member 51 thus extends above and along the top frame part 20′. The bottom end 56 of the brace member 50 comprises a plate 106 for being fastened via fasteners 108 to the top frame part 20′. Any gaps between the plate 106 and the top frame part 20′ can be filled by plate shims 110.

The front end post 252i includes ratchet connectors 292 connected at the inner side 262b of the post member 256. The rear end post 252ii includes hook connectors 294 having a base 295 connected at the inner side 262b of the post member 256 with the hook elements 296 protruding forwardly.

The strap structure 35 comprises side straps 114 comprising a bare end 298 for being connected to the ratchet connector 292 and reinforced loop end 300 for being connected to the hook element 296. The hook element 296 provides a top opening 301 allowing the loop 300 to be slipped on and off but maintained in place by the top and inwardly extending finger stopper 302.

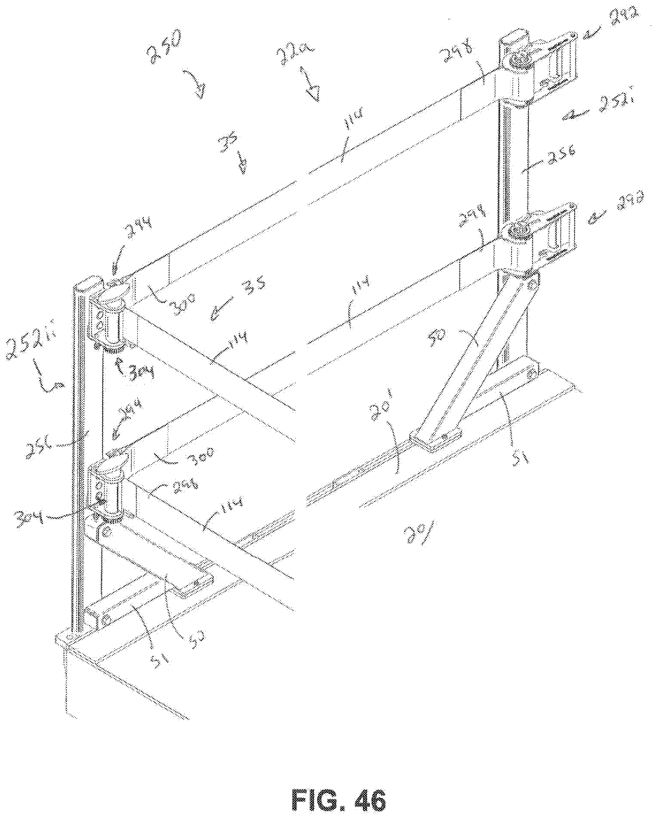

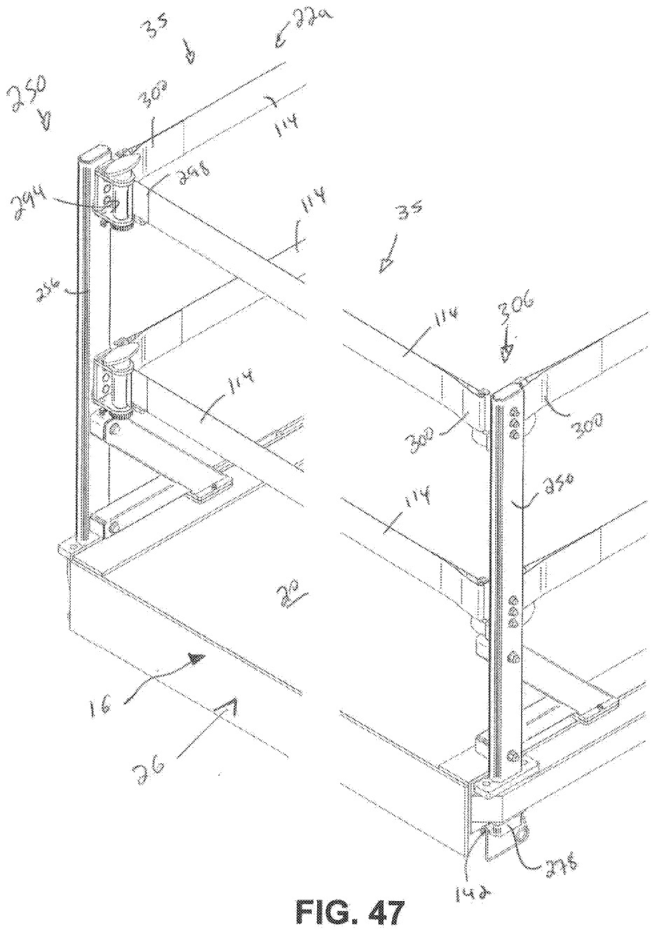

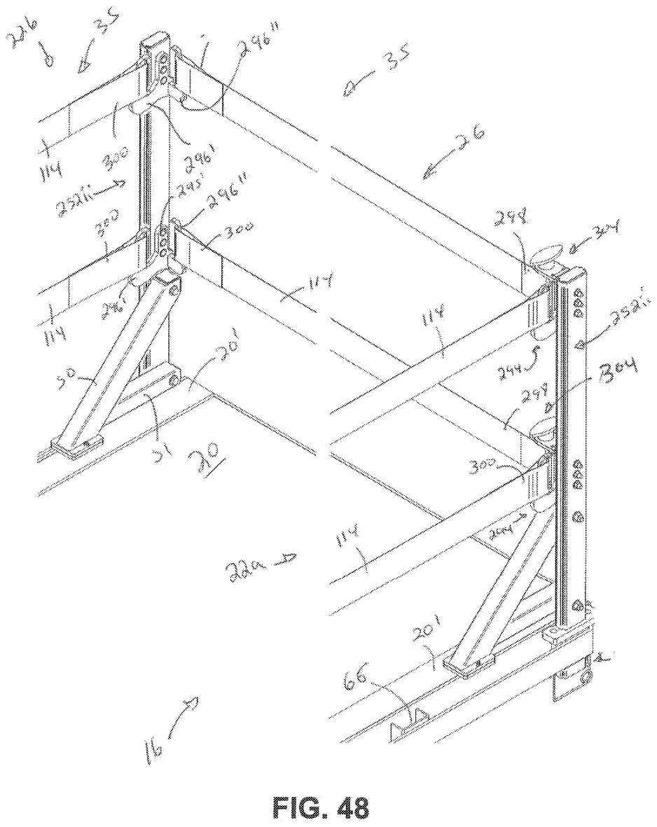

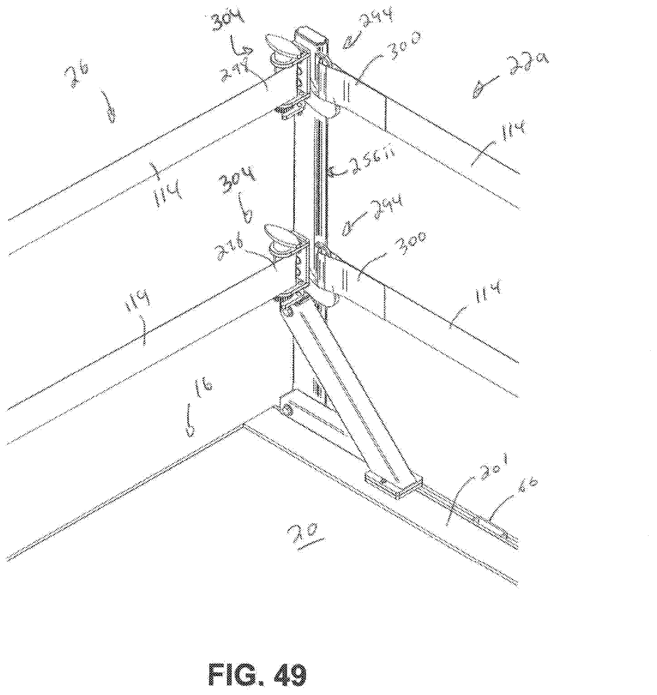

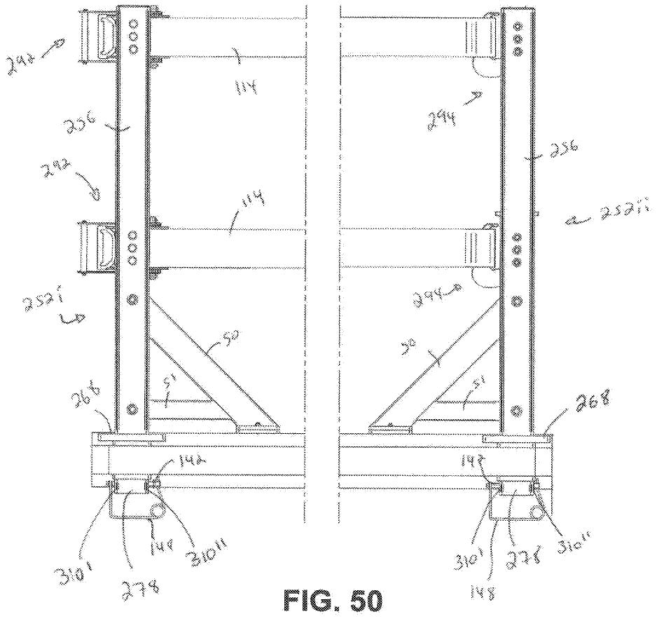

With reference to FIG. 43, the temporary barrier structure 250 is shown in a closed tail configuration. In this configuration, the rear end post 252ii of lateral side 22a comprises winch connectors 304 in addition to the hook connectors 294 and the rear end post 252ii of lateral side 22b comprises double hook connectors 306 which will be further described hereinbelow with reference to FIGS. 46 to 50.

FIG. 44 is a sectional view of the post member 256. In an embodiment, the post member 256 comprises inner open spaces 308 with partition walls 309 for stiffening a post 256 such as an aluminum extrusion post. The front and rear protruding rails can be filed down to fit the notches 284 of a particular clamping plate 280. Similarly, the lateral 262a and 262b can also be filed down to fit a particular channel 282 of a plate 280. The shaded areas in FIG. 44 show the maximum amount of material that can be removed from a post member 256.

In another embodiment, the same type of plate 280 is always used as it comes with the present system but the pockets 66 of various flatbeds 16 may be provided in a variety of shapes and thus filing down the shaded areas shown in FIG. 44 allows the lower section 276 to be adjusted in size to snuggly fit the stake pockets 66 on a truck 10.

FIG. 45 shows a variety of gauges 312 in the form of a lower section 276 with each gauge providing different size variations of the shaded areas namely of the front and rear sides 264′ and 264″ and the protruding rails 266 thereof and the lateral sides 262a and 262b. Thus, a user can verify what size configuration of the lower section 276 will snuggly fit into a given stake pocket 66 by using the variety of gauges. Gauge size can be indicated on the posts 256 to facilitate distribution and installation.

In an embodiment, the bottommost portions 278 of the post members 256 are not provided with a bottom clamping plate member 280 but rather the mounting assembly 267 comprises a locking pin 142 as previously described mounted to portion 278 for securing the post members 256 of the end posts 252i and 252ii to the stake pockets 66. The foregoing is shown in FIGS. 46 to 50 which illustrate the same temporary barrier 250 as previously described with regard to FIGS. 36 to 45 with the difference of using the locking pin 142 rather than clamping plate 280 with bolts 88 and fastening elements 87 and 89 and as such only the differences will be described hereinbelow as all other elements remain the same.

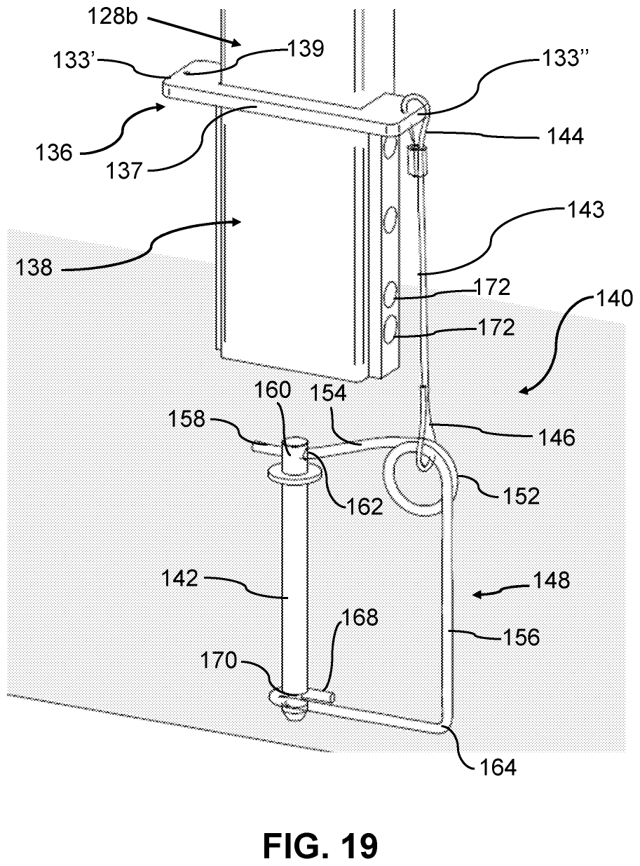

Indeed, the bottom post portion 278 defines co-aligned front and rear holes 310′ and 310″ (see FIGS. 41, 42 and 50) for receiving the pin 142 therethrough which engages the bottom rim 91 of the pocket 66 stopping upward movement of the post member 156 which secures the posts 252i and 252ii to the pockets 66. A spring 148 is mounted to the pin 142. The structure and operation of the pin 142 and spring 148 have been described in detail at FIG. 19 for example and thus are reiterated here by reference thereto.

With reference to FIGS. 37, 43, and 46 to 49, the closed tail configuration of the temporary barrier 250 will now be described whether the posts 252i or 252ii are clamped or pinned to the stake pocket 66.

The inner side 262b of the post member 256 of the rear end post member 252ii of lateral side 22a includes the winch connectors 304 which is mounted to the base 295 of the hook connector.

The inner side 262b of the post member 256 of the rear end post member 252ii of lateral side 22b includes the winch double hook connector 306 having a base 295′ mounted to the inner side 262b and having one hook element 296′ forwardly extending in the direction of the front end post 252i of lateral side 22b and another hook element 296″ extending towards the rear end post member 252ii of lateral side 22a forming right angle between the two hook elements 296′ and 296″.

At lateral side 22a, the strap structure 35 comprises side straps 114 comprising a bare end 298 for being connected to the ratchet connector 292 of the front end post 252i and a reinforced loop end 300 for being connected to the hook element 296 of the rear end post 252ii. At the rear side 26, the strap structure 35 comprises rear straps 114 comprising a bare end 298 for being connected to the winch 304 and reinforced loop end for being connected to the hook element 296″. At lateral side 22b, the strap structure 35 comprises side straps 114 comprising a bare end 298 for being connected to the ratchet connector 292 of the front end post 252i and a reinforced loop end 300 for being connected to the hook element 296′ of the rear end post 252ii.

As previously stated, midway or intermediate posts 254 are mounted to the lateral sides 22a and 22b of the flatbed 16 between the front and rear end posts 252i and 252ii. The intermediate posts 254 are received within stake pockets 66.

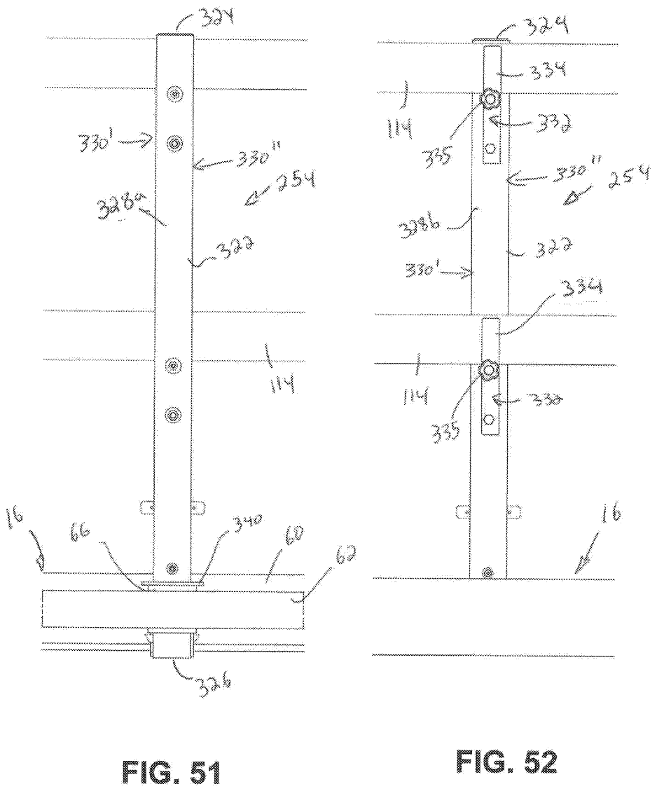

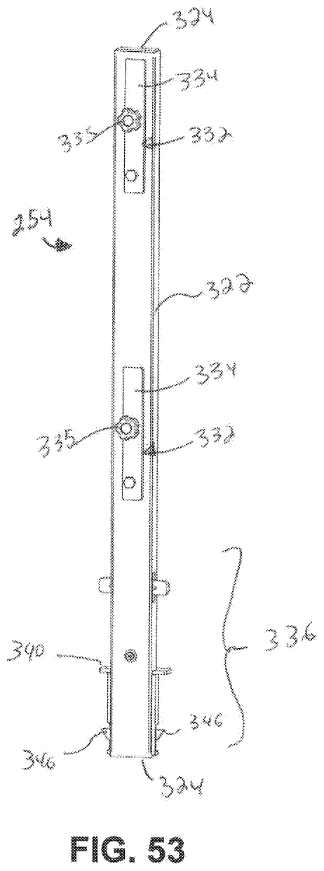

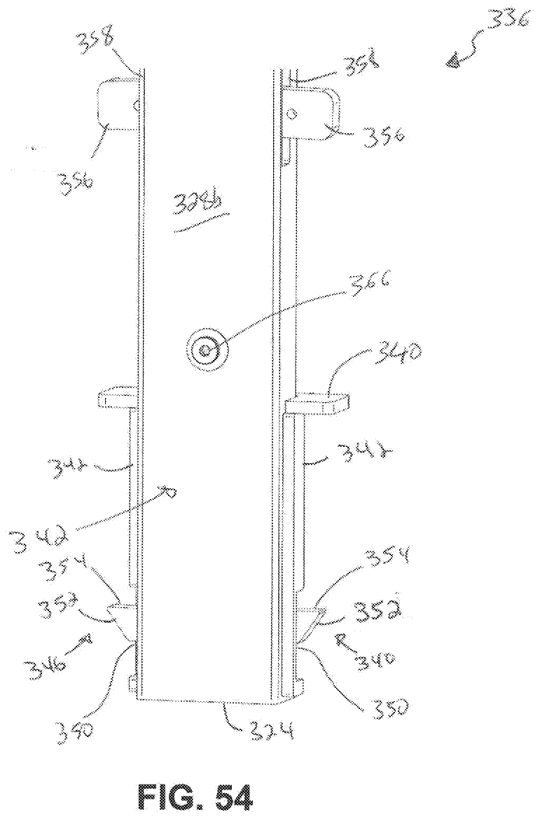

FIGS. 51 and 52 respectively show outboard and inboard views of the intermediate post 254 when mounted to the flatbed 16. FIG. 53 shows the intermediate post 254 disconnected from the flatbed 16. With reference 51, 52 and 53, the intermediate post 254 comprises an elongate body 322 defining top and bottom ends, 324 and 326, outer and inner lateral sides 328a and 328b and front and rear sides 330′ and 330″. The terms “front” and “rear” sides are interchangeable as they depend on whether the elongate body 322 is on the left or right lateral sides 22a or 22b. The inner later sides 328b face the flatbed platform 20 (i.e. they are inboard) and the outer lateral sides 328a face outboard away from the platform 20. The inner side 328b includes clamps 332 for clamping a strap member to the intermediary post 254. In this example, the clamp 332 includes an elongate clamp member that can be released or tightened onto the inner side 328b via an adjustment knob 335.

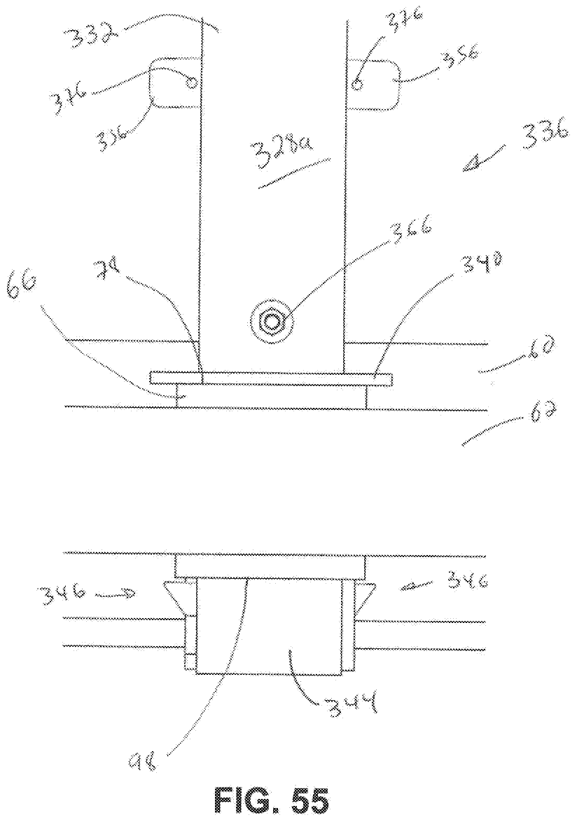

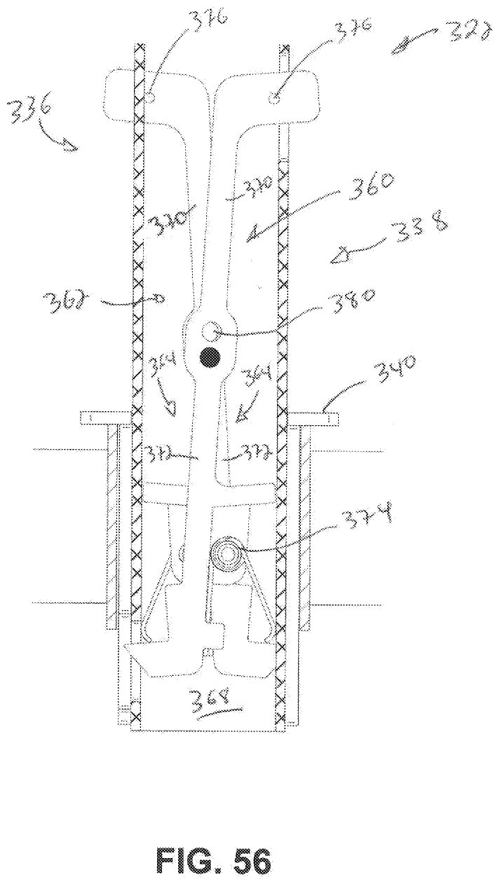

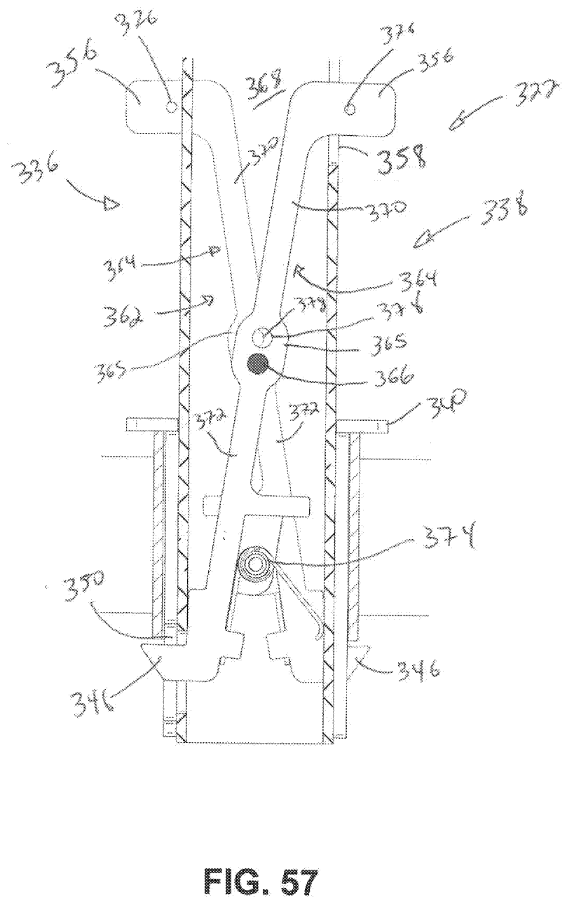

With reference to FIGS. 53 to 57, the intermediate post 254 defines a lower section 336 that comprises a mounting assembly 338 for being mounted to the stake pocket 66. The lower section 336 includes a stopper plate 340 extending from the outer side 328a and the front and rear sides 330′ and 330″. The plate 340 defines a bottom section 342 of this lower section 336 of the elongate body 322 extending thereunder and being fitted within the stake pocket 66 until the plate 340 engages the top rim 78 to be stopped thereby. A bottommost portion 344 of the section 342 protrudes outwardly via opening 71 of the stake pocket 66 and comprises abutments in the form of hooks 346 that engage the bottom rim 91 when the post 254 is pulled upwardly thereby being stopped thereby. Thus, the bottom section 342 between the plate 340 and the hooks 346 is secured to the stake pocket 66. The front and rear sides 330′ and 330″ of the bottom section 342 include protruding rails 348 which can be filed down to fit various pocket sizes.

The hooks 346 are movable they are outwardly biased through respective holes 350 at the front and rear sides 330′ and 330″ and are pushed inwardly when the bottom section 342 is inserted into the pocket 66 via top opening 70 and they slidingly engage the rim 71 and the inner walls of the pocket 66. The hooks 346 are wing shaped with inwardly oriented sides 352 (from a rear wider end 354 to a narrower front or leading end 356) that are convenient for such insertion and once the bottom most portion 344 protrudes from bottom pocket opening 71 the wing like hooks 346 are outwardly deployed and provide the rear wider ends 354 to engage the rim 91 of the pocket 66 to be stopped thereby.

In order to move the hooks 346 inwardly into holes 350, the user manually pushes lever tabs 356 into holes 358 formed at the front and rear sides 330′ and 330″. The lever tabs 356 outwardly protruding from holes 358 and are outwardly biased. The lever tabs 356 are inwardly pushed into holes 358 against the biasing force thereby moving the hooks 346 into holes 350 and when the lever tabs 356 are released from being pushed, the biasing force moves both the lever tables 356 out of holes 358 and the hooks 346 out of holes 350.

With particular reference to 56 and 57 the foregoing relationship between the tables 356 and hooks 346 will be further described. The mounting assembly 338 comprises an internal scissor or X linkage structure 360 withing housed within an internal chamber 362 defined by the lower section 336. The X linkage structure 360 comprises a pair of link members 364 connected together at their mutually engaging central structures 365 including a pivot 366 which pivotally connects the members 364 together and which is secured to the inner walls 368 of defined lateral sides 328a, 328b. The link members 364 define respective upper extending arms 370 extending above the pivot 366 and defining the lever tabs 356 at their top ends. The link members 364 define respective lower extending arms 372 extending below the pivot 366 and defining the hooks 346 at their bottom ends. A biasing spring 374 is positioned beneath the pivot 366 and between the arms 372 and being connected to the arms 372 to bias the arms 372 away from each other towards an open position thereby providing a biasing force such that the tabs 356 and the hooks 346 protrude out of their respective holes 358 and 350. The user will thus push the lever tabs 346 to move the arms 370 closer together and to the move the arms 372 closer together against the biasing force of the spring 374 to move the hooks 346 into holes 350 as discussed above.

The tabs 356 include indicia such as indicator holes 376 that when visible indicate that the tabs 356 are in the fully outwardly extended position which correspondingly means that hooks 346 are in the full outwardly extended position as well and thus properly engage the rim 91 of the pockets 66 for locking the posts 254 thereto.

The central structures 365 of the link members define respective secondary holes 378 that are aligned to define a common secondary pivot 380 for engagement of lock bars in deeper stake pockets.

The skilled artisan is hereby directed to the following online resources for further non-limiting exemplary implementations relating to the operation, installation and set-up of the embodiments described with reference to FIGS. 36-57: https://trukrail.com/ and https://trukrail.com/wp-content/uploads/2026/01/TrukRail-Installation-Manual-2026-01-19_v02.pdf which are incorporated herein by reference in their entirety.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

What is claimed is:

1. A temporary barrier for a flatbed of a truck, the flatbed comprising a frame structure with a platform extending therein and defining front and rear ends thereof, the frame structure defining outer sides extending along and downwardly of the platform, the outer sides comprising pockets having top and bottom openings, the temporary barrier comprising:
front and rear end posts comprising:
respective end post elongate vertical members having an end post bottom portion thereof for being placed within the pocket; and
respective end post mounting assemblies for mounting the end post bottom portions to the pockets;
intermediate posts comprising:
respective intermediate post elongate vertical members having an intermediate post bottom portion thereof for being placed within the pocket; and
respective intermediate post mounting assemblies for mounting the intermediate post bottom portions to the pockets; and
a strap structure mounted to the front and rear posts and the intermediate posts.

2. A temporary barrier according to claim 1, wherein the intermediate post vertical members respectively comprise an upper stopper element for engaging the pocket during insertion of the intermediate post bottom portion into the pocket to stop further insertion therein.

3. A temporary barrier according to claim 2, wherein the upper stopper comprises a plate member.

4. A temporary barrier according to claim 1, wherein the intermediate post bottom portion defines a bottommost part that outwardly extends from the bottom opening of the pocket when the bottom portion is fully inserted in the pocket, wherein the intermediate post mounting assemblies respectively comprises a stopper element at the bottommost part for stopping removal of the intermediate post from the pocket via engagement with the pocket.

5. A temporary barrier according to claim 4, the bottommost part defining openings for receiving the bottom stopper.

6. A temporary barrier according to claim 5, wherein the bottom stopper comprises a pin.

7. A temporary barrier according to claim 1, wherein the intermediate post mounting assemblies respectively comprise movable hook members outwardly protruding from openings formed in a bottommost part of the intermediate post bottom portion that are inwardly movable during insertion of the intermediate post bottom portion into the pocket, the bottommost part outwardly extending from the bottom opening of the pocket providing the hooks to outwardly protrude for stopping removal of the intermediate post from the pocket via engagement with the pocket.

8. A temporary barrier according to claim 7, wherein the hook members are biased to outwardly protrude from the openings in the bottommost part via a biasing element.

9. A temporary barrier according to claim 7, wherein the intermediate post mounting assemblies respectively comprise movable lever tabs outwardly protruding from openings formed in the intermediate post elongate vertical members and being connected to the hooks via a linkage structure, wherein inward pushing of lever tabs into the openings of the intermediate post elongate vertical members causes inward movement of the hooks into the openings of the bottommost part.

10. A temporary barrier according to claim 1, wherein the end post vertical members respectively comprise an upper stopper element for engaging the pocket during insertion of the end post bottom portion into the pocket to stop further insertion therein.

11. A temporary barrier according to claim 10, wherein the upper stopper element comprises a plate.

12. A temporary barrier according to claim 1, wherein the end post bottom portion defines a bottommost part that outwardly extends from the bottom opening of the pocket when the bottom portion is fully inserted in the pocket, wherein the end post mounting assemblies respectively comprise a bottom stopper element at the bottommost part for stopping removal of the end post from the pocket via engagement with the pocket.

13. A temporary barrier according to claim 12, the bottommost part defining openings for receiving the bottom stopper.

14. A temporary barrier according to claim 13, wherein the bottom stopper comprises a pin.

15. A temporary barrier according to claim 1, wherein the end post bottom portion defines a bottommost part that outwardly extends from the bottom opening of the pocket when the bottom portion is fully inserted in the pocket, the mounting assemblies respectively comprise:
a top clamping plate mounted to the end post elongate vertical member for engaging the pocket during insertion of the end post bottom portion into the pocket to stop further insertion therein; and
a bottom clamping plate mounted to the bottommost part for stopping removal of the end post from the pocket via engagement with the pocket,
wherein the top and bottom clamping plates are interconnected.

16. A temporary barrier according to claim 1, wherein the vertical elongate members of the end posts and/or the rear posts comprise external material that is removable for fitting into a given pocket size.

17. A temporary barrier according to claim 1, wherein the strap structure comprises a plurality of straps.

18. A temporary barrier according to claim 17, wherein one of the front and rear end posts comprise connectors for connecting the straps thereof.

19. A temporary barrier according to claim 18, wherein the connectors are selected from the group consisting of connecting ratchets, winches, quick links, hooks and any combination thereof.

20. A temporary barrier according to claim 17, wherein the intermediate posts comprise clamps for receiving and clamping the straps.
